(19) United States
(12) Patent Application Publication
(10) Pub. No.: US 2014/0289754 A1
(43) Pub. Date: Sep. 25, 2014

(54) PLATFORM-INDEPENDENT INTERACTIVITY WITH MEDIA BROADCASTS

(71) Applicant: Sven Riethmueller, Newburyport, MA (US)

(72) Inventor: Sven Riethmueller, Newburyport, MA (US)

(21) Appl. No.: 14/223,269

(22) Filed: Mar. 24, 2014

Related U.S. Application Data
(63) Continuation of application No. 13/650,896, filed on Oct. 12, 2012, now abandoned.
Application No. 13/650,896 is a continuation of application No. PCT/US2011/032569, filed on Apr. 14, 2011.
(60) Provisional application No. 61/324,105, filed on Apr. 14, 2010.

(51) Int. Cl. H04N 21/442; H04N 21/8358; H04N 21/84

(52) U.S. Cl. CPC H04N 21/442; H04N 21/84; H04N 21/8358
USPC 725/19

(57) ABSTRACT

A method is disclosed including: receiving a broadcast media sequence; comparing broadcast media sequence and a reference media sequence; generating broadcast information related to the broadcast media sequence based on the comparison of the broadcast media sequence and the reference media sequence; and providing interactivity related to the broadcast media sequence to at least one viewer based on the broadcast information.

### CROSS-REFERENCE TO RELATED APPLICATIONS

This application claims benefit of U.S. Provisional Application Ser. No. 61/324,105 filed Apr. 14, 2010, the entire contents of which are incorporated herein by reference.

The subject matter of this application is also related to International Patent Application Serial No. PCT/US2008/060164, filed Apr. 13, 2008 and International Patent Application Serial No. PCT/IB2009/005407 filed Feb. 28, 2009, International Patent Application Serial No. PCT/US2009/040361, filed Apr. 13, 2009, and International Patent Application Serial No. PCT/US2009/054066 filed Aug. 17, 2009. The entire contents of each of the related applications are incorporated by reference herein.

### FIELD OF THE DISCLOSURE

The present disclosure relates to sequence comparison in media streams. Specifically, the present invention relates to techniques for providing platform independent interactivity with media broadcasts.

### BACKGROUND

The availability of broadband communication channels to end-viewer devices has enabled ubiquitous media coverage with image, audio, and video content. The increasing amount of multimedia content that is transmitted globally has boosted the need for intelligent content management. Providers must organize their content and be able to analyze their content. Similarly, broadcasters and market researchers want to know when and where specific footage has been broadcast. Content monitoring, market trend analysis, and copyright protection is challenging, if not impossible, due to the increasing amount of multimedia content. However, a need exists to improve the analysis of media content in this technology field.

Platform independent interactivity is not possible for many types of media broadcasts (e.g., television broadcasts). Media broadcasts may be transmitted using a variety of platforms (e.g., cable, satellite, terrestrial antenna, computer network, internet, wireless networks, etc.). Typically these broadcasts only provide one way communication from the broadcaster to the viewer. For some platforms (e.g., cable or satellite) some interactivity may be provided using additional hardware or software, e.g., a set to box for a television, systems integrated with a television (e.g., internet enabled televisions), internet television systems (e.g., systems marketed under the Apple TV and Google TV trade names), however this technology is typically platform dependent and requires cooperation and integration with the platform provider (e.g., a cable or satellite provider).

Television advertising faces challenges not only from other media (internet, mobile communications, etc) but also from technologies, such digital video recorders (DVRs) that enable viewers to record programs for later viewing and to skip advertisements. As a result, television advertisement as the major source of revenue for the television industry is under threat. One current approach, demanding revenue sharing of subscription fees from cable and other delivery platform operators, renders television content providers more dependent on individual platforms. In addition, this approach does not improve actual viewership of advertisements (commercials, television programs with product placement, etc.), a key interest of advertisers and content providers.

### SUMMARY

The applicant has realized that the techniques described herein may be used to create platform independent interactivity with media broadcasts. The content (e.g., audio, video, mixed audio and video, data such as metadata, etc.) of one or more broadcast channels are monitored (without any cooperation required by platform providers) to generate information about the media being broadcast (e.g., the identity and air time of a program, program segment, commercial, etc). This information is used to provide interactivity with one or more viewers of the broadcast. For example, in some cases, the interactivity may take the form a real time or near real time content synched with the broadcast and sent to one or more devices (cell phone, computer, gaming system, etc) associated with the viewer. In some cases the interactivity may take the form of opportunities for the viewer to send messages in response to events which occur in the broadcast (e.g., the appearance of a certain product) to obtain rewards, access to exclusive content, etc. Additional types of interactivity are detailed herein. The applicant has realized that by providing platform independent interactivity, viewers can be encouraged to watch a broadcast live and to watch advertisements included in the broadcast.

In one aspect, a method's disclose including: receiving (or generating) a first descriptor corresponding to a broadcast media sequence; comparing the first descriptor and a second descriptor corresponding to a reference media sequence; generating broadcast information related to the broadcast media sequence based on the comparison of the first descriptor and the second descriptor; and providing interactivity related to the broadcast media sequence to at least one viewer based on the broadcast information.

In some embodiments, providing interactivity related to the broadcast media sequence to at least one viewer includes: receiving viewer information from the at least one viewer; and determining a relationship between the viewer information and the broadcast information.

Some embodiments include selectively providing content to at least one device associated with the at least one viewer based on the relationship between the viewer information and the broadcast information.

Some embodiments include selectively storing information associated with the viewer based on the relationship between the viewer information and the broadcast information.

In some embodiments, the viewer information includes information related to the time of an action of the at least one viewer. In some embodiments, determining the relationship between the viewer information and the broadcast information includes: determining, based on the broadcast information, action time information indicative of whether the time of the action corresponds to an event in the broadcast media sequence.

Some embodiments include determining, based on the action time information, whether the time of the action was within a defined time period of the event.

In some embodiments, the viewer information includes information related to the location of the at least one viewer at the time of the action. In some embodiments, determining the relationship between the viewer information and the broadcast information includes: determining, based on the broadcast information, action location information indicative of whether the location of the at least one viewer at the time of the action corresponds to a location where the broadcast media sequence is available.

Some embodiments include providing content to at least one device associated with the at least one viewer based on the action time information or the action location information.

In some embodiments, the content includes at least one selected from the list consisting of: a text based message audio content; video content; an image; an advertisement a response solicitation access rights, a question, a menu option, and an internet link.

Some embodiments include, based on the action time information or the action location information, storing information associated with the viewer.

In some embodiments, the information associated with the viewer includes at least one selected from the list consisting of: a response to response solicitation; a response to a question; a vote; a loyalty program reward; a lottery entry; location information; demographic information; an email address; a postal mail address, an IP address; a telephone number.

Some embodiment include, based at least in part on the viewer information, influencing the content of the broadcast media sequence.

In some embodiments, generating broadcast information related to the broadcast media sequence based on the comparison of the first descriptor and the second descriptor includes: determining a similarity of the first and second descriptors; and comparing the similarity to a threshold level.

In some embodiments, the broadcast information includes threshold information indicative of whether the similarity exceeds the threshold level.

In some embodiments, providing interactivity related to the broadcast to at least one viewer includes: based on the broadcast information, providing substantially real time content to at least one device associated with the viewer related to an event in the broadcast media sequence.

In some embodiments, providing substantially real time content to the at least one viewer includes delivering event content associated with a respective event in the broadcast media sequence substantially simultaneously with the event.

In some embodiments, the event content is delivered within 360, 240, 120, 60, 30, 10, 5, 1, or less seconds of the event, e.g., within 1-360 seconds.

In some embodiments, the content includes at least one selected from the list consisting of: text content, audio content, video content, an image.

In some embodiments, the event content includes an advertisement or response solicitation related to the respective event.

In some embodiments, providing substantially real time content includes: generating a first list of descriptors, each descriptor corresponding to respective event in the broadcast media sequence; comparing at least a first one from the first list of descriptors to a second list of descriptors to identify a first identified event in the broadcast media sequence; and synchronizing a delivery of the real time content to the at least one viewer based on the first identified event.

Some embodiments include, prior to the comparing step, receiving information from the at least one viewer indicating viewer interest in the broadcast.

In some embodiments, the descriptors in the first list of descriptors are generated at distinct time intervals during the broadcast media sequence.

In some embodiments, the descriptors in the first list of descriptors are generated substantially continuously during the broadcast media sequence.

Some embodiments include after the synchronizing step, comparing a second one from first list of descriptors to the second list of descriptors to identify a second event in the broadcast; and re-synchronizing the delivery of the real time content to the at least one viewer based on the identified first event.

In some embodiments, the broadcast information includes: broadcast identity information indicative of an identity of the media content of the broadcast media sequence; and broadcast time information indicative of a time during which the broadcast media sequence was broadcast.

In some embodiments, the broadcast information includes one or more of broadcast match information indicative of a similarity between the first descriptor and the second descriptor, broadcast location information indicative of a location in which the broadcast media sequence was broadcast, broadcast platform information indicative of a platform over which the broadcast media sequence was broadcast, and broadcast channel information indicative of a channel over which broadcast media sequence was broadcast.

In some embodiments, the device is selected from the list consisting of: a mobile phone, a phone, a computer, a television, a set top box, a tablet device, a personal digital assistant, and a pager.

In some embodiments, providing content includes transmitting an instruction to a content provider to deliver content to a device associated with the at least one viewer.

In some embodiments, the broadcast media sequence includes at least one selected from the list consisting of: an audio sequence, a video sequence, a multimedia sequence, a data sequence, and a metadata sequence related another media.

In some embodiments, the broadcast media sequence includes a live generated content.

In some embodiments, the broadcast media sequence includes prerecorded content.

In some embodiments, the broadcast media sequence is transmitted via at least one selected from the list consisting of: a radio signal, an over air television signal, a satellite signal, a cable signal, a computer network, a local area network, a wide area network, a cellular network, a wireless network, a public switched telephone network, and the internet.

In another aspect, a system is disclosed including: a broadcast monitoring module configured to: receive a first descriptor corresponding to a broadcast media sequence; compare the first descriptor and a second descriptor corresponding to a reference media sequence; and generate broadcast information related to the broadcast media sequence based on the comparison of the first descriptor and the second descriptor. In some embodiments, the broadcast information is configured to facilitate providing interactivity related to the broadcast media sequence to at least one viewer.

Some embodiments include a storage module in communicatively couple to the broadcasting module and configured to store a plurality of reference descriptors each corresponding to a respective reference media sequence.

In some embodiments, the plurality of reference descriptors includes the second descriptor.

Some embodiments include an interactivity module communicatively couple to the broadcast monitoring module and configured to: receive viewer information from the at least one viewer; and determine a relationship between the viewer information and the broadcast information.

In some embodiments, the interactivity module is configured to selectively provide content to at least one device associated with the at least one viewer based on the relationship between the viewer information and the broadcast information.

In some embodiments, the interactivity module is configured to determine if an action of the viewer occurred within a defined time period from an even in the broadcast media sequence.

In some embodiments, the interactivity module is configured to selectively store information associated with the viewer based on the relationship between the viewer information and the broadcast information.

In some embodiments, the content includes at least one selected from the list consisting of: a text based message; audio content; video content; an image; an advertisement; a response solicitation; access rights, a question, a menu option, and an internet link.

In some embodiments, the information associated with the viewer includes at least one selected from the list consisting of: a response to response solicitation; a response to a survey question; a vote; a loyalty program reward; a lottery entry; location information; demographic information; an email address; an IP address; a telephone number.

In some embodiments, the interactivity module is configured to: based at least in part on the viewer information, influencing the content of the broadcast media sequence.

In some embodiments, the monitoring module includes a comparison module configured to: generate the broadcast information related to the broadcast media sequence based on the comparison of the first descriptor and the second descriptor by: determining a similarity of the first and second descriptors; and comparing the similarity to a threshold level.

In some embodiments, the broadcast information includes threshold information indicative of whether the similarity exceeds the threshold level.

In some embodiments, the interactivity module is configured to: based on the broadcast information, provide substantially real time content to at least one device associated with the viewer related to an event in the broadcast media sequence.

In some embodiments, the interactivity module is configure to: provide substantially real time content to the at least one viewer includes delivering event content associated with a respective event in the broadcast media sequence substantially simultaneously with the event.

In some embodiments, the event content is delivered within 360, 240, 120, 60, 30, 10, 5, 1, or less seconds of the event, e.g., within 1-360 seconds.

In some embodiments, the content includes at least one selected from the list consisting of: text content, audio content; video content, and an image.

In some embodiments, the event content includes an advertisement or response solicitation related to the respective event.

In some embodiments, the monitoring module and interactivity module are configured to: generate a first list of descriptors, each descriptor corresponding to respective event in the broadcast media sequence; compare at least a first one from the first list of descriptors to a second list of descriptors to identify a first event in the broadcast media sequence; and synchronize a delivery of the real time content to the at least one viewer based on the identified first event.

In some embodiments, the interactivity module is configured to receive information from the at least one viewer indicating viewer interest in the broadcast.

In some embodiments, the descriptors in the first list of descriptors are generated at distinct time intervals during the broadcast media sequence.

In some embodiments, the descriptors in the first list of descriptors are generated substantially continuously during the broadcast media sequence.

In some embodiments, the monitoring module and interactivity module are configured to: comparing a second one from first list of descriptors to the second list of descriptors to identify a second event in the broadcast; and re-synchronizing the delivery of the real time content to the at least one viewer based on the identified first event.

In some embodiments, the broadcast information includes: broadcast identity information indicative of an identity of the media content of the broadcast media sequence; and broadcast time information indicative of a time during which the broadcast media sequence was broadcast.

In some embodiments, the broadcast information includes: broadcast match information indicative of a similarity between the first descriptor and the second descriptor.

In some embodiments, the broadcast information includes: at least one from the list consisting of: broadcast location information indicative of a location in which the broadcast media sequence was broadcast; broadcast platform information indicative of a platform over which the broadcast media sequence was broadcast; and broadcast channel information indicative of a channel over which broadcast media sequence was broadcast.

In some embodiments, the interactivity module is configure to provide content by transmitting an instruction to a content provider to deliver content to a device associated with the at least one viewer.

In some embodiments, the broadcast media sequence includes an audio sequence or a video sequence.

In some embodiments, the broadcast media sequence includes at least one selected from the list consisting of: an audio sequence, a video sequence, a multimedia sequence, a data sequence, and a metadata sequence related another media. In some embodiments, the broadcast media sequence includes a prerecorded media sequence.

Some embodiments include a communication module communicatively couple to the monitoring module and configured to receive the broadcast media sequence.

In some embodiments include a descriptor generation module communicatively couple to the communication module and configured to: receive the broadcast media sequence; and process the broadcast media sequence generate the first descriptor.

In some embodiments, the descriptor generation module is configured to: process the broadcast media sequence generate a list of descriptors each descriptor corresponding to respective event in the broadcast media sequence.

In some embodiments, the descriptors in the list of descriptors are generated at distinct time intervals during the broadcast media sequence.

In some embodiments, the descriptors in the list of descriptors are generated substantially continuously during the broadcast media sequence.

In another aspect, a method is disclosed including: receiving a broadcast media sequence; comparing broadcast media sequence and a reference media sequence; generating broadcast information related to the broadcast media sequence based on the comparison of the broadcast media sequence and the reference media sequence; and providing interactivity related to the broadcast media sequence to at least one viewer based on the broadcast information.

In another aspect, a system is disclosed including: a broadcast monitoring module configured to: receive a broadcast media sequence; compare the broadcast media sequence and a reference media sequence; and generate broadcast information related to the broadcast media sequence based on the comparison of the first descriptor and the second descriptor. In some embodiments, the broadcast information is configured to facilitate providing interactivity related to the broadcast media sequence to at least one viewer.

In another aspect, a computer program product including a non-transitory machine readable medium having instructions stored thereon, the instructions being executable by a data processing apparatus to implement the steps of any of the above recited methods.

Various embodiments may include any of the elements described above, either alone or in any suitable combination.

As used herein, the term “based on” is to be understood to mean “based at least partially on.” For example, if a first piece of information is said to be generated based a second piece of information, it is to be understood that the first piece of information may be generated based on the second piece of information along with additional pieces of information.

As used herein the term “viewer” is used to generically describe any individual receiving content (e.g., a broadcast media sequence), regardless of the type. For example, an individual receiving an audio-only broadcast would be considered to be a viewer, even though the received content does not include a visual component.

### BRIEF DESCRIPTION OF THE DRAWINGS

The foregoing and other objects, features, and advantages of the present disclosure, will be more fully understood from the following description of various embodiments, when read together with the accompanying drawings.

FIG. 1 illustrates a system for creating platform independent interactivity with a media broadcast;

FIG. 2 is a block diagram of a system for creating platform independent interactivity with a media broadcast;

FIG. 3 is a flow diagram illustrating a process for monitoring a media broadcast;

FIG. 4 is an exemplary data packet generated by the process illustrated in FIG. 3;

FIG. 5 illustrates a functional block diagram of an exemplary system;

FIG. 6 illustrates a functional block diagram of an exemplary content analysis server;

FIG. 7 illustrates an exemplary block diagram of an exemplary multi-channel video comparing process;

FIG. 8 illustrates an exemplary flow diagram of a generation of a digital video fingerprint;

FIG. 9 illustrates an exemplary result of a comparison of two video streams;

FIG. 10 illustrates an exemplary flow chart of a generation of a fingerprint for an image;

FIG. 11 illustrates an exemplary block process diagram of a grouping of frames;

FIG. 12 illustrates an exemplary block diagram of a brute-force comparison process;

FIG. 13 illustrates an exemplary block diagram of an adaptive window comparison process;

FIG. 14 illustrates an exemplary block diagram of a clustering comparison process;

FIG. 15 illustrates an exemplary block diagram of an identification of similar frame sequences;

FIG. 16 illustrates an exemplary block diagram of similar frame sequences;

FIG. 17 illustrates an exemplary block diagram of a brute force identification process;

FIG. 18 illustrates an exemplary block diagram of an adaptive window identification process;

FIG. 19 illustrates an exemplary block diagram of a extension identification process;

FIG. 20 illustrates an exemplary block diagram of a hole matching identification process;

FIG. 21 illustrates an exemplary flow chart for comparing fingerprints between frame sequences;

FIG. 22 illustrates an exemplary flow chart for comparing video sequences;

FIG. 23 illustrates a block diagram of an exemplary multi-channel video monitoring system;

FIG. 24 illustrates an exemplary flow chart for the digital video image detection system; and

FIGS. 25A-25B illustrate an exemplary traversed set of K-NN nested, disjoint feature subspaces in feature space.

### DETAILED DESCRIPTION

### Overview

By way of general overview, in various embodiments, the technology described herein compares broadcast media content to other reference media content using a broadcast monitoring module. The broadcast and reference media content may be of any suitable type including, for example, audio, video, combined audio and video, digital information (including metadata attached, embedded or otherwise related to other media types), etc. The reference media content can be obtained from any source able to store, record, or play media (e.g., a broadcast television source, network server source, a digital video disc source, etc.). The broadcast media content can be obtained from any broadcast platform (a radio signal, an over air television signal, a satellite signal, a cable signal, a computer network, a local area network, a wide area network, a cellular network, a wireless network; a public switched telephone network, the internet, etc.). The monitoring module enables automatic and efficient comparison of digital content, allowing information about the broadcast media content to be generated in real time or near real time. The monitoring module may include a content analysis processor or server, is highly scalable and can use computer vision and signal processing technology for analyzing footage in the video and in the audio domain in real time.

Moreover, the monitoring module's automatic content comparison technology is highly accurate. While human observers may err due to fatigue, or miss small details in the footage that are difficult to identify, embodiments of the monitoring module are routinely capable of comparing content with an accuracy of over 99%. The comparison does not require prior inspection or manipulation of the footage to be monitored. The monitoring module mat extract the relevant information from the multimedia stream data itself and can therefore efficiently compare a nearly unlimited amount of multimedia content without manual interaction.

In some embodiments, the monitoring module generates descriptors, such as digital signatures—also referred to herein fingerprints—from the received broadcast media content. In various embodiments, the digital signatures describe specific video, audio and/or audiovisual aspects of the content, such as color distribution, shapes, and patterns in the video parts and the frequency spectrum in the audio stream. Each sample of media may be assigned a (potentially unique) fingerprint that is basically a compact digital representation of its video, audio, and/or audiovisual characteristics.

The monitoring module utilizes such descriptors to conduct comparisons to find identical, similar and/or different frame sequences or clips in a reference media. In other embodiments, this comparisons may be carried out as a direct comparison of media streams, without the generation of descriptors.

Accordingly information related to the identity of the broadcast media may be generated. For example, in some embodiments, a sample sequence of the broadcast media may be identified as a particular commercial or television show segment. In other embodiments a sample sequence of the broadcast media may be identified as corresponding to a particular class or type of media. For example, a broadcast television show may be identified as belonging to a particular television series, without necessarily identifying the particular episode within the series. Similarly, the broadcast sample sequence may be identified as a one of a group of commercials for a particular product, without necessarily identifying which particular commercial in the group corresponds to the broadcast sample.

As detailed herein, the information about the broadcast media may be utilized to provide interactivity to one or more viewers of the broadcast. The interactivity may be provided in a completely platform independent fashion, with no cooperation from the platform providers (e.g., the cable and/or satellite providers broadcasting the media to various groups of viewers).

### Exemplary Interactivity System

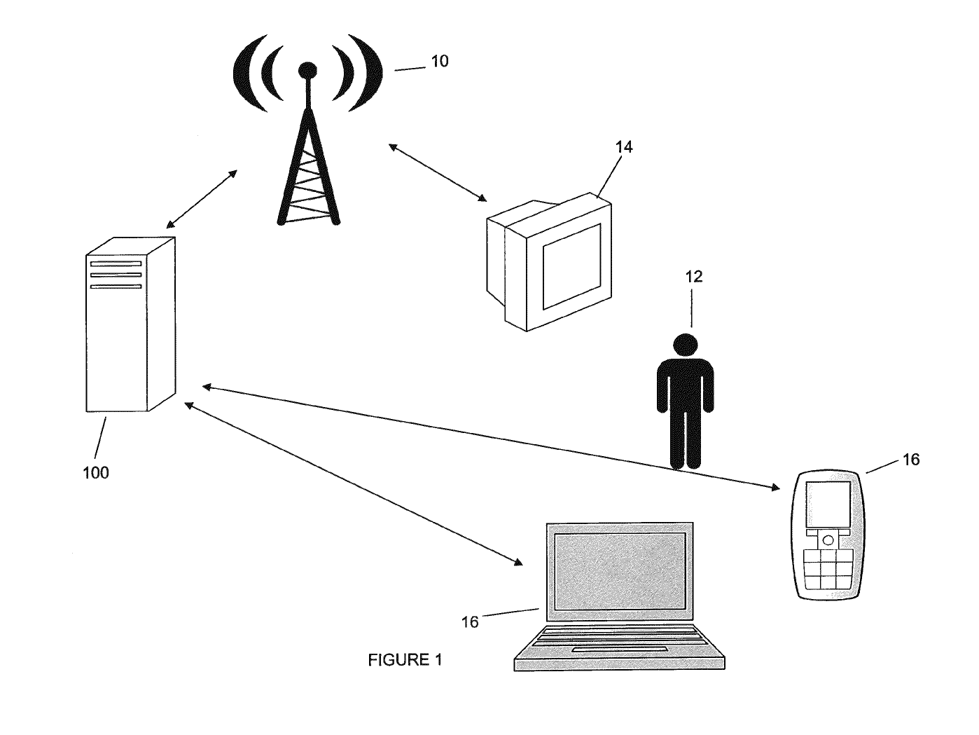

FIG. 1 illustrates a system 100 for implementing platform independent interactivity for a medial broadcast. A broadcast source 10 broadcasts a media sequence (e.g., a television signal or other video stream) which is viewed by a viewer 12 on a viewing device 14 (as shown, a television). The system 100 also receives the broadcast media sequence and processes the broadcast to determine information about the broadcast media stream, e.g., using the comparison techniques described in detail herein. This information is then used to provide interactivity, e.g., through communicating with one or more devices 16 (as shown, a laptop computer and a telephone) associated with the viewer 12. In some embodiments the system 100 may provide interactivity by communicating with a computer system or application (not shown) associated with the viewer. For example, system 100 may interact via an application programming interface to interact with a social media application associated with the viewer.

Communication between the system 100 and the devices 16 may one-way, two-way, or any other suitable form. The communication may occur over a direct link (e.g., a direct wired or wireless link) or an indirect link (e.g., using a private or open network, the internet, etc.) In some embodiments, the communication may involve a third party intermediary. For example, a text message sent from a viewers device may go to a third party server, which then processes the message and passes all or part of the information contained in the viewer's message (or information derived therefrom) to system 100 (e.g., via an email message).

As shown, system 100 is located remotely from the viewer 12. For example, system 100 may be implemented on one or more servers or other computer systems. If multiple servers or systems are used, they may communicate with each other using any suitable communication link (e.g. a private or public network).

In some embodiments, some or all of system 100 may be located at or near the viewer's location. For example, some or all of system 100 may be implemented in a set top box attached to the viewer's viewing device 14 or may be implemented using equipment integrated with the viewing device 14.

In some embodiments, system 100 may receive the broadcast media sequence indirectly from for broadcast source 10. For example, broadcast source 10 may broadcast a television signal which is received by a viewing device (viewing device 14, as shown, or another device). All or some of the output of the viewing device (e.g., video, audio, combined video/audio, etc.) may be received by a recording device (e.g., a camera, a microphone, etc.) (not shown) which produces a secondary media stream based on the broadcast media stream, which is then transmitted to system 100 for processing.

As detailed below, the interactivity may be provided in real time or substantially real time (also referred to herein as “near real time”). That is, the interactivity may closely synchronized to events which occur in the broadcast media stream. For example, in one embodiment, the broadcast media stream may include a commercial with respect to which the viewer is prompted (or has previously been informed) to send a text message or other response to a particular phone number or other address (e.g. an html link, IP address, etc.) within a defined time period after the commercial is broadcast in order to obtain a reward (e.g. an online coupon). The system 100 can monitor the broadcast to identify in real time or in near real time (e.g., within a few minutes or less) the airing of the commercial, thereby providing information that can be used to verify that the viewer's text response is sent during the defined time period. In other embodiments, a variety of types real time interactivity may be provided, e.g., as set forth in greater detail below.

In general, the system 100 and the viewer's devices 16 may communicate using any suitable communication technology including, text messaging (SMS, MMS, etc.), email, wired or wireless telephone calls, any type of network communication or digital data transfer, etc. In some embodiments, the communication may be facilitated using one or more applications, either located on the device itself or remotely accessed (e.g., using an internet browser).

In some embodiments, the system 100 and the viewing device 14 may also communicate such that viewing device can be considered one of the devices 16 associated with the viewer. For example, if viewing device 16 is a network enabled television (or a television connected to a network enabled set top box), system 100 may transmit content over the network to be displayed on the viewing device (e.g., alongside or overlaid on the broadcast being viewed). Similarly, the networked television could be used to allow the viewer to send information to the system 100.

As shown in FIG. 1, the system 100 does not include any platform dependent components. Other than receiving that broadcast media stream for the broadcast source 10, system 100 does not communicate or interact with the broadcast source 10. The system 100 independently monitors the broadcast media stream to identify events in the broadcast, and therefore does not need to rely on third party information (e.g., publically available program schedules) which may be inaccurate (e.g., due to programming changes caused by programs of uncertain length such as sporting events), incomplete, insufficiently detailed, etc., or may fail to schedule the relevant content (e.g., the schedule of commercials or commercial break times are not typically provided in television schedules). Further, the system 100 provides interactivity without communicating or interacting with any special equipment (e.g., a set top box) connected to the viewing device 14. Note that although a platform independent system provides several advantages, it is to be understood that in some embodiments, one or more platform dependent components may be included.

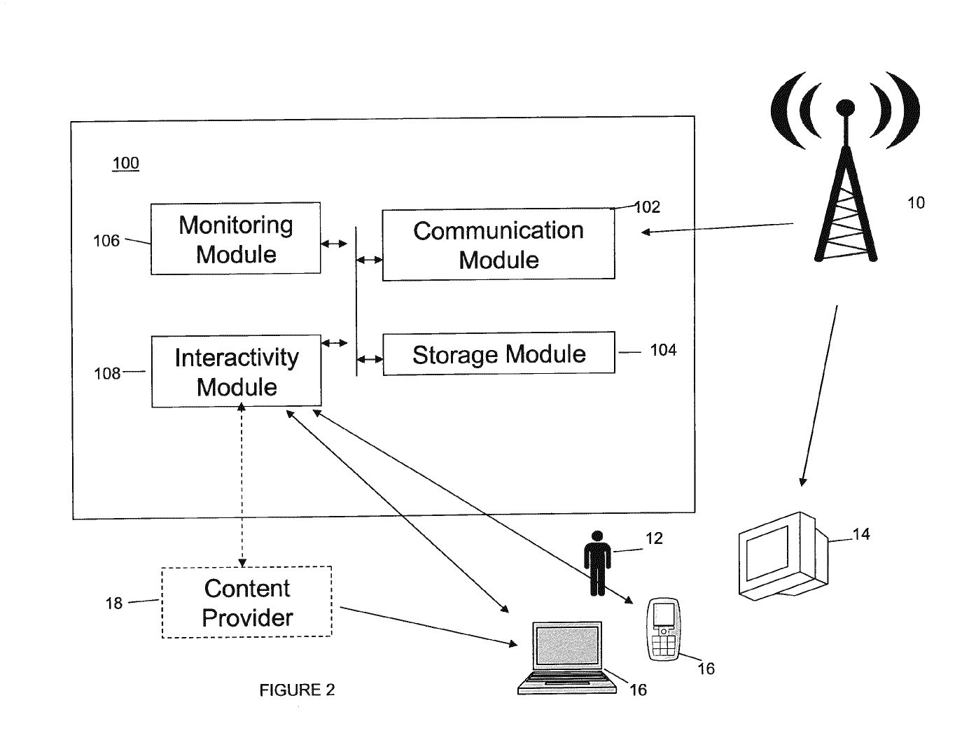

FIG. 2 illustrates a block diagram of one embodiment of the system 100. The system 100 includes a communication module 102 which receives one or more broadcast media streams (e.g., corresponding to various television channels) from broadcast source 10. Although one broadcast source is shown, in various embodiments the communication module 102 may receive any number of media streams from any number of sources. The sources may be of any suitable type, including, e.g., a radio signal source, an over air television signal source (terrestrial or satellite), a cable source, a computer network, a local area network, a wide area network, a cellular network, a wireless network; a public switched telephone network, and the internet.

A storage module 104 stores information related to reference media sequences. The storage module 104 may include a list of descriptors each corresponding to a segment (e.g., one or more video frames) of a reference media sequence. For example, a descriptor may correspond to a segment of a television show or a commercial advertisement. The storage unit 104 may store various supplementary information related to the descriptors, e.g., information related to the identity, length, content, or other characteristic of the corresponding media segment.

A monitoring module 106 cooperates with the communication module 102 and the storage module 106 to compare a broadcast media sequence to one or more reference media sequences to determine information about the broadcast sequence.

In some embodiments the monitoring module 106 compares the broadcast media sequence to determine a level of similarity between the sequences. The comparison may be carried out directly, or, as described herein, one or more descriptors related to each of the sequences may be received or generated and then compared.

In some embodiments, if the level of similarity is determined to be above a threshold level, the broadcast media sequence may be identified with the reference media sequence. The level of similarity between the descriptors may be calculated based on any suitable metric including, for example a pixel by pixel comparison of image frames, a Minkowsi type metric, Mean Square Error type metric, Mean Absolute Error metric, etc. The level of similarity may be calculated using any of the comparison techniques described below and/or set forth in the international patent applications incorporated by reference above.

In various embodiments, the comparison may be highly accurate. For example, in various embodiments, a broadcast media sequence may be identified (e.g., as similar to or identical to a reference sequence) with accuracy of at least 50%, 75%, 80%, 85%, 90%, 95%, 97%, 97%, 98%, 99%, or more. For example, in some embodiments the system 100 may identify a pair of media sequences as having a level of similarity above a selected threshold level with an accuracy of at least 50%, 75%, 80%, 85%, 90%, 95%, 97%, 97%, 98%, 99%, or more.

In some embodiments, this identification (e.g., at the various accuracy levels set forth above) may be carried out very quickly. For example, in some embodiments a broadcast sequence may be identified within a short period of time (sometimes referred to as a latency time) after the sequence is received by the system 100. In some embodiments this latency time may be less than a few minutes, e.g., less than 360 seconds, 240 seconds, 180, seconds, 120 seconds, 90 seconds, 60 seconds, 30 seconds, 15 seconds, 10 seconds, 1, seconds, or less (e.g., in the range of 1-360 seconds).

In some embodiments, the identification may be carried (e.g., at the accuracy levels described above) out using media sequences of a short duration, e.g. less than 360 seconds, 240 seconds, 180, seconds, 120 seconds, 90 seconds, 60 seconds, 30 seconds, 15 seconds, 10 seconds, 1, seconds, or less (e.g., in the range of 1-360 seconds). For video sequences, this short duration may correspond to a small number of frames, e.g., less than 10,000 frames, 1,000 frames, 100 frames, 10 frames, or even a single frame.

The information about the broadcast media sequence determined by the monitoring unit 106 may be passed on to interactivity module 108 to produce interactivity with viewer 12. For example, the interactivity module may interact directly with the devices 16 associated with the viewer 12. For example, interactivity module 108 and the viewer's devices 16 may communicate using any suitable communication technology including, text messaging (SMS, MMS, etc.), email, wired or wireless telephone calls, any type of network communication or digital data transfer, etc. In some embodiments, the communication may be facilitated using one or more applications, either located on the device itself or remotely accessed (e.g., using an internet browser). Alternatively or additionally, the interactivity module 108 may interact with a content provider 18 external to system 100, which in turn interacts (by any suitable communication technology) with the devices 16.

The interactivity module 108 may further communicate with one or more third party systems (not shown). For example, as described in the examples below, in some embodiments the viewing provided with access rights (e.g., access to exclusive web content, permission to view a limited access television channel, etc.) based in the viewer's interaction with the system 100. The interactivity module 108 may communicate with one or more third party systems to facilitate the provisions of these access rights (e.g., by requesting a third party internetserver allow the viewer to access the exclusive web content, or by requesting that a third party television system (which may be a cable, satellite, interne based, or other type of provider) give the viewer the right to view the limited access television channel). This communication may be two-way (e.g., the third party server may provide access information, such as a code or password, to interactivity module 108, which can in turn pass the access information on to the viewer).

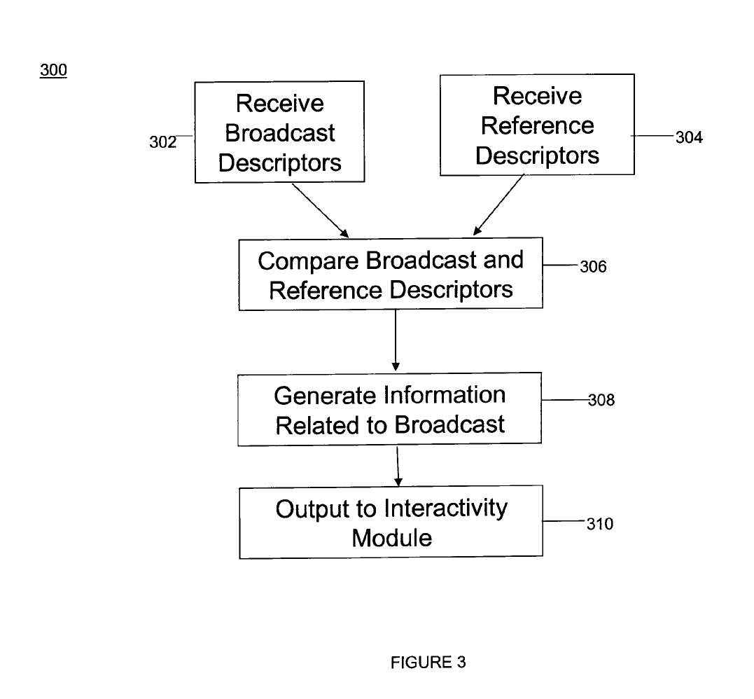

FIG. 3 is a flow chart illustrating an exemplary process 300 implemented by monitoring module 106. In step 302, monitoring module 106 receives one or more descriptors related to a broadcast media sequence. For example, these descriptors can be generated “on the fly” in real time or near real time by processing the broadcast media sequence, e.g., using the techniques described in greater detail below. In step 304 monitoring module 106 receives one or more descriptors related to a reference media sequence. These descriptors can be generated by processing reference media sequences obtained from any suitable source, and stored in storage unit 104. The reference descriptors can be generated on “on the fly” or, more typically, generated previously and stored. For example, if the monitoring unit is intended to identify the broadcast of commercials for a given product, these commercials can be processed to generate descriptors which can then be stored in the storage unit. Note that both the broadcast and reference descriptors can be generated simply be processing the associate media, and therefore do not require any modification of the media (e.g., using digital watermarking) or cooperation of the broadcasting platform provider.

In step 306, the broadcast and reference descriptors are compared to determine information about the broadcast media sequence. For example, the similarity of a broadcast descriptor to one or more reference descriptors may be determined. The level of similarity may be compared to a threshold level and, if the threshold level is met or exceeded, segment of the broadcast media sequence corresponding to the broadcast descriptor may be identified with the segment of the reference media corresponding to the reference descriptor. In some embodiments, this identification indicates an exact match between the broadcast and reference media segments. In other embodiments, the identification indicates only that the segments are similar (e.g., that the segments both belong to a single class of similar, but not identical, media segments).

In various embodiments, the comparison step 306 may be performed “on the fly” in real time or near real time. For example, in some embodiments an event in the broadcast media sequence (e.g., the airing of a specific commercial or television program segment) may be identified based on the comparison within a few minutes of the occurrence of the event, or even faster (e.g., within 180 seconds, 120 seconds, 60 seconds, 30 seconds, 10 seconds, 1 second, or even substantially simultaneous with the event).

In step 308, information related to the broadcast is generated based on the comparison performed in the comparison step 306. In step 310, the information about the broadcast media sequence is output, e.g., to interactivity module 108, for further processing.

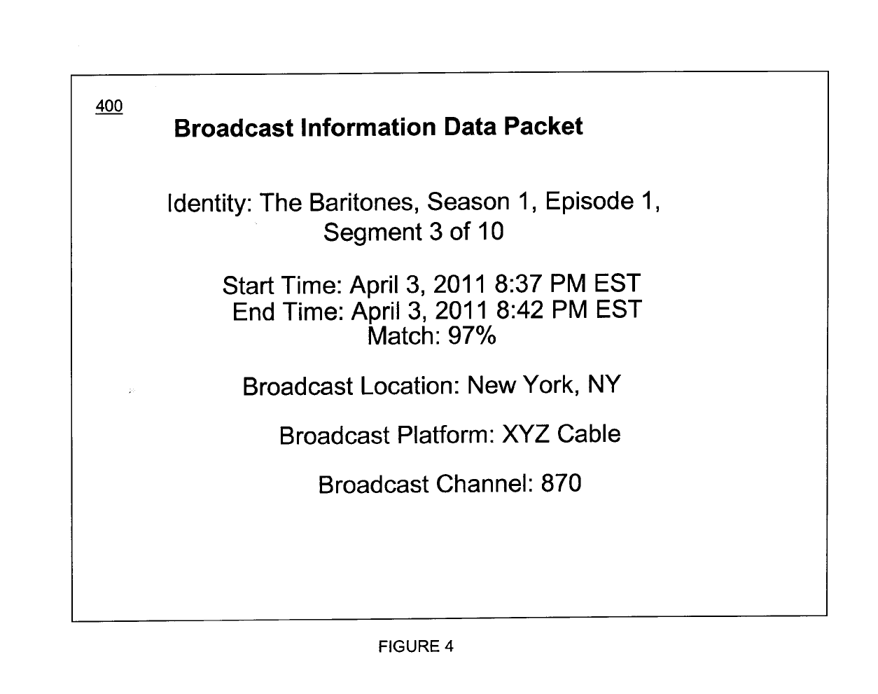

In some embodiments, the generated and/or output information includes a data packet 400 of the type shown in FIG. 4 containing a variety of information about the broadcast media sequence. As shown, the information includes:
broadcast identity information indicative of the identity of the media content (as shown, “The Baritones”, Season 1, Episode 1, Segment 3 of 10);
broadcast time information indicative of the time during which the broadcast media sequence was broadcast (e.g., start time and/or end time);
broadcast match information indicative of the similarity between the broadcast descriptor and the reference descriptor (as shown, 97% similarity);
broadcast location information indicative of the location in which the broadcast media sequence was broadcast (as shown, New York, N.Y.);
broadcast platform information indicative of the platform over which the broadcast media sequence was transmitted (as shown, XYZ Cable Company);
broadcast channel information indicative of the channel over which the broadcast media sequence was transmitted (as shown, channel 870).

In various embodiments, some of this information may be omitted and/or additional information may be included. The amount of information included may, in some embodiments, effect the scope of the interactivity which may be provided based. For example, in one embodiment, the information in the packet is to be used to validate that a viewer response (e.g., text message or email) was sent within a defined period of the airing of a video segment or commercial featuring a specific product. In some such (or other) embodiments, at a minimum the following information would be necessary: the approximate time of the broadcast media sequence within certain predefined ranges (which does not need to specify the specific start time, only that during a certain time period on the date, the sequence was shown), the fact that the threshold value was achieved (which may optionally be communicated solely by the fact that the data packet was generated) and some identifier of the video clip (which does not need to be unique for each video clip but may simply confirm that it is a member of a group of video sequences e.g. a the identifying information may only indicate that video sequence featuring a particular product or commercial for a particular product was shown irrespective of which segment/commercial was actually broadcast).

As noted above, the information generated by the monitoring unit may be processed by interactivity module 108 to provide various types of viewer interactivity. In some embodiments the information is compared to viewer information provided by or related to an action performed by the viewer. For example, this comparison may confirm whether a viewer action was performed within a defined period of the broadcast of a particular media segment in the viewer's location. The defined period may take have any suitable length, e.g., any length in the range of 1 seconds to three minutes. If the viewer's action is validated, the system 100 may respond by selectively providing content to the viewer (e.g., a text message including a discount code or an advertisement or access information). Alternatively or additional, the system 100 may selectively store information related to the viewer (e.g., a response a vote, a loyalty program reward, a lottery entry, location information, demographic information, an email address, a postal mail address, an IP address; a telephone number). Validation schemes of this type are useful in a variety of applications, just a few of which are described below.

In one application, a viewer views a commercial broadcast on television (whether delivered by satellite, cable, terrestrial antenna, etc.) in real time. The commercial invites viewer to call a telephone number or send a text message or email during a time window around the broadcast of the commercial (alternatively viewers may already be aware that they should call or text or email, e.g., based on a prior marketing campaign).

If viewer does so, viewer will receive some sort of reward or other content, for example a coupon, a gift card, a discount code, access to exclusive online content, the appearance of an image or link or button in a web browser or mobile application, assess right to third party systems, etc. The viewer could additionally or alternatively be entered into a lottery or similar giveaway to win a reward for having timely called the number or send a text message. The viewer may receive a response (e.g. hear a message when calling or receiving a text message or email reply) confirming his timely call or text, which may contain other messages (e.g. advertisement) or further interactivity (e.g. a response solicitation, a survey question, etc.). A viewer who calls the number or sends the text message outside this time window is not eligible.

In another application, every time a viewer views a commercial featuring a product or brand, or a product or brand is shown during television programming (whether delivered by satellite, cable, terrestrial antenna, etc.) in real time, the viewer calls a telephone number or sends a text or email message during a time window around the broadcast of the commercial. If viewer does so, his call is recorded and counted. After achieving a threshold number of calls or texts, the viewer earns a reward, for example a discount coupon that the viewer can apply when the viewer next purchases the product or brand. In an alternative, the viewer can earn points or credits towards the review if he views specified other commercials or products/brands in real time (e.g. a competitor's product). The viewer may receive a response (e.g. hear a message when calling or receiving a text or email message reply) confirming his timely call or text or email, which may contain other (advertising) messages or further interactivity. A viewer who calls the number or sends the text message outside this time window is not eligible. This can be combined with any other brand loyalty or rewards program. For example, viewing advertisements for airlines could be combined with the airlines existing miles rewards program.

In another application, the viewer views a program on television (whether delivered by satellite, cable or terrestrial antenna) in real time; as certain scenes are broadcast, the viewer interacts with a different medium (e.g. interne web site, mobile app, or by sending and responding to text or email messages or calling certain phone numbers) by voting on certain questions posed to the viewer which are tied to the content of the television broadcast and the interactivity in the other medium requires real time or near real time responses to the content as its is broadcast on television. By so voting and responding, the viewers can influence (e.g., by majority vote) in real time the actual content of the broadcast. For example, if a character in a movie needs to make a decision what dress to wear, the ultimate choice broadcast will depend on the majority vote of the viewers interacting with the program as described above. As in the examples above, the votes may only be counted if made during a prescribed time window around a triggering event in the broadcast show. Votes made outside of the time window would have no impact on the broadcast content.

In some embodiments, the information determined by the monitoring module may be processed by the interactivity module to facilitate delivery of content to the devices 16 associated with the viewer 12 in real time or near real time. The real time content can be associated with one or more events in the broadcast media system. In some embodiments, the delivery of the content can by synchronized or substantially synchronized with the event or events. For example, event related content can be delivered with a few minutes or less of the corresponding broadcast event (e.g., within 360 seconds, 300 seconds, 240 seconds, 180 seconds, 120 seconds, 60 seconds, 30 seconds, 10 seconds, 1 second, or even substantially simultaneously) (e.g. within 1-360 seconds). The delivered content may include text content, audio content, video content; an image, access to a website, a survey question or other invitation for a response, or any other suitable content.

It is to be understood that, for synchronized content to be provided which is temporally matched to a particular event in the broadcast sequence (e.g., the delivery of a text message or other content at or within a defined time period of the appearance of a product in a movie scene) the system need not directly detect the event (e.g., the product appearance). Instead, the system 100 can monitor the broadcast sequence to identify some other occurrence (e.g., the beginning of the movie). The identified (sometimes referred to as “tagged”) occurrence can then be used (potentially in combination with other information) as a reference to provide the synchronized content. For example, in the case of the movie, the system may store or access information which indicates that a product placement occurs three minutes after the beginning of the movie. Once the beginning of the movie is identified, the text message (or other content) can be sent three minutes hence, so as to arrive just as the product placement occurs. As will be readily understood to one skilled in the art, indirect identification or tagging schemes of this type may be used, as appropriate, in any of the techniques and example described herein. This indirect tagging may be particularly useful in application where some latency time occurs in the processing of the broadcast media sequence.

In some embodiments, synchronized real time content delivery can be achieved even when a continuous stream of broadcast descriptors in not available. For example, one embodiment, a descriptor for a portion of the broadcast media sequence is generated at regular or irregular intervals (e.g., every 2 minutes). The system 100 receives an indication from the viewer (e.g., via text message or a mobile application) that the viewer is watching or otherwise interested in the broadcast.

The system waits until the next broadcast descriptor is generated (for descriptors generated at regular 2 minute intervals, the wait time will never be more that 2 minutes and, on average, will be less). Once the descriptor is generated, it is compared to reference descriptors to identify the corresponding broadcast segment (e.g., to determine that the segment corresponds to the 7^{th} minute of a particular 30 minute episode). This information can be used (optionally in combination with additional stored information related to the identified broadcast media) to provide synchronized content. For example, if it is known that a product placement event occurs during the 12^{th} minute of the identified episode, the system can wait 5 minutes (adjusted as necessary for processing and latency times) and then transmit a survey question to the viewer's mobile phone just as the product placement event occurs. The above process can be repeated periodically to re-synchronize the provide content with the broadcast (e.g., to compensate for platform specific variations in the length of commercial breaks).

Real time content synchronization schemes of this type are useful in a variety of applications, just a few of which are described below. However it is to be understood that, for some applications, real time synchronization is not required. In such (and other) cases, system 100 may be used to simply monitor the broadcast media sequence and provide related content to the viewer. For example, in one embodiment, the system 100 may identify the general type of programming being viewed by the viewer (e.g., sports, arts, news, etc.), a television series being viewed, etc. and provide content to the viewer which is not closely synchronized to events in the broadcast. For example, if the system 100 determines that the viewer is viewing a broadcast related to home improvement, the system may cause advertisements related to home improvement to appear in a web browser on the viewer's laptop.

Returning to example of synchronized content, in one application, a viewer views a commercial or program on broadcast television (by satellite, cable, terrestrial antenna, etc) in real time. The system 100 monitors the broadcast to identify the occurrence of a particular commercial or scene. Promptly after the commercial or scene is broadcast, the viewer is sent a text message or otherwise contacted with a message soliciting a response (e.g. requesting a response to what was just shown, such as a reaction to the product, commercial or scene just shown). If the viewer does so (and answers the question correctly), viewer will receive some sort of reward, for example a coupon, or “credits” or “points” under the applicable loyalty program. As discussed above, viewers who do not respond within a specified time period following the text or cannot answer the question posed or otherwise react to the solicitation are not eligible.

In another application, a viewer views a commercial or program on broadcast television (by satellite, cable, terrestrial antenna, etc.) in real time. The viewer interacts with the content (e.g. scenes) shown on television in real time by interacting with a different medium (e.g. internet web site, mobile app, or by sending and responding to text messages or calling certain phone numbers) where the interactivity in the different medium is tied to the content of the television broadcast as monitored by the system 100. In some embodiments, the interactivity in the other medium requires real time or near real time responses or reactions to the content as its is broadcast on television. Three examples of this type of interactivity are (1) for the viewer to respond to questions in real time as the program is broadcast (to earn a reward, credit etc), (2) for the viewer to call up additional information (for example view additional value-add content available) or separate or parallel story lines in real time as the program is broadcast, (3) for the viewer to give feedback on certain scenes as they are shown (e.g. focus group reactions) and receiving a reward or compensation for responding on time

In some embodiments, interactivity may be provided even for live generated content broadcasts. A live generated content broadcast may include at least partially predictable and/or repetitive scenes. For example, at the end of each inning of a live broadcast baseball game, a graphic will be shown summarizing the score of the game. The basic format of the graphic is repetitive and predictable.

A reference descriptor can be generated and stored corresponding to the at least partially predictable and/or repetitive scenes. The system 100 can then generate “on the fly” descriptors for the live broadcast, and identify a live broadcast descriptor that is similar to the reference descriptor for the at least partially predictable and/or repetitive scenes. This identification can then be used to facilitate interactivity, using any of the techniques described above. For example, in the case of the live baseball broadcast, the system can monitor for and identify the end of inning score summary graphic, and provide content related to and/or synchronized with the end of the inning (e.g., a survey question asking the viewer to vote if the manager should make a pitching change). In other embodiments, techniques of this type could be applied to many different types of live broadcast, e.g., to facilitate real time voting for contestants on reality television type games shows.

Other examples of identifiable repetitive scenes which may be used in this fashion (either with a live generated or recorded broadcast media sequence) to facilitate interactivity include, for example, the appearance of the face of an individual (e.g., a recurring character in a television series, a host or judge on a game show, etc.), a recurring activity (e.g., the passage of a basketball through the hoop during a broadcast game, an exterior shot of an often visited location in a movie, etc.). The system 100 may monitor the broadcast media sequence to identify scenes which are similar to a reference scene (e.g., having a level of similarity above a threshold level). For example, in one embodiment, a scene in a broadcast television show is found to be more than 75% similar to a reference scene showing the face of a recurring character, the scene is identified as an appearance of that character. If the viewer sends a response (e.g., via text message, email, using a mobile application or web browser) within a defined time period of the appearance, the viewer receives a response, reward, etc.

In general, in various embodiments, the systems and techniques described herein provide a number of benefits and advantages. As discussed above, the technology may be platform independent, operating without the need for any cooperation of platform providers.

The viewer does not need to install any special equipment, such as a set top box. Instead, interactivity is provided through the viewer's devices such as mobile phones and computer. Many viewers are already accustomed to conducting interactive activities on these devices.

The technology does not require watermarking or any other special modification of the broadcast content, and therefore can leverage previously produced programming. The technology can provide an incentive for viewers to watch commercials in real time, rather than skipping over them using DVRs or similar devices.

In various embodiments the technology allows for the collection of viewer information including demographic information and viewing habit information. This information may represent valuable marketing data.

Various embodiments presented herein describe communication between the viewer and system 100 using a particular technology (e.g., via text message or email). It is to be understood that any suitable communication technology may be used, including a network enables computer application (e.g., a mobile application) a web browser based system, etc.

Although the examples above relate to monitoring and providing interactivity with a broadcast media stream, in other embodiments, the broadcast source may be replaced by a recorded media source. The recorded source may be a private source, e.g., a viewer's DVR recorder. The recorded content which currently being viewed (or otherwise accessed) may take the place of the broadcast media sequence in the examples herein. Interactivity is then provided for with the content being viewed. For example, system 100 may monitor the playback of a recorded movie from a viewer's DVR to provide interactivity. In some embodiments, the monitoring may be performed locally, requiring that all or some of system 100 to be co-located or integrated with the recorded media source. In other embodiments, system 100 may be remote from, but in communication with, the recorded media source.

### EXAMPLES

As will be understood by one skilled in the art, the techniques described herein may be applied in a wide array of applications. The following examples are provided for illustrative purposes only, and should not be considered limiting in any way.

### Example 1

### Loyalty Program

In this example, ABC Automotive (“ABC”), a car manufacturing company, creates a loyalty program. Every time a viewer views one of ABC's commercials or sees on of ABC's cars in a scene in certain specified movies or shows (whenever shown), and sends as text or email message or calls a phone number from the viewer's phone during or immediately (e.g. within 1 minute) after the commercial or scene, the viewer's call with be recorded and the viewer earns a point. The system described above may store reference descriptors corresponding to ABC's commercials and to segments of a variety of movies and shows (both new and old) featuring ABC's cars. As described above, the system will compare descriptors generated from a broadcast media sequence to these reference descriptors to identify when the relevant commercials or segments air. This information is then used to validate the viewer's responses. Note that these reference descriptors can be generated simply be processing the associate media, and do not require any modification of the movies/shows (e.g., digital watermarking) or cooperation of the broadcasting platform provider. This allows ABC to leverage prior product placements. For example, if a channel broadcasts a rerun of an older movie which features cars from the car company (e.g. an ABC car which a famous spy character drover during 1960's era movies), the viewer can call while or shortly after a scene showing the car in the movie

This program is similar to familiar airline mileage programs. If the viewer has collected a specified number of points during a specified time period, the viewer receives a discount coupon towards purchase of her next ABC car or some other reward (e.g., the opportunity to test drive a rare vintage ABC sports car).

### Example 2

### Giveaway

In this example, Johnson's Furniture Company (“JF”) creates a giveaway program. Every time a television viewer views one of JF's commercials in a certain predefined market (e.g. Boston, Mass.) and during a specified period (e.g., 1 week), and sends as text or email message or calls a phone number from the viewer's phone during or immediately (e.g., within 1 minute) after the commercial during this period, the viewer's call with be recorded and the viewer is automatically entered into a giveaway and can win one of a specified number of products (e.g., a music player). The contact information may be provided in the commercial, or via other channels. A system of the type described herein automatically receives, validates, and records the messages and calls from the viewers to conduct the giveaway program. When the viewer makes the timely call, he will have to provide certain contact information (and may have to provide certain market research information) and will then receive a response back (e.g. text message back or email) with certain additional promotional messages and confirmation that the viewer is entered into the contest/giveaway and separate notice if the viewer won.

### Example 3

### Instant Discount

In this example JF creates an instant discount program. Every time a television viewer views one of JF's commercials in a certain predefined market (e.g. Boston, Mass.) and during a specified period (e.g., 1 week), and sends as text or email message or calls a phone number from the viewer's phone during or immediately (e.g., within 1 minute) after the commercial during this period, the viewer's call with be recorded and the viewer will automatically receive an additional 20% discount when purchasing furniture from the company within 30 days thereafter. A system of the type described herein automatically receives, validates, and records the messages and calls from the viewers to conduct the discount program. When the viewer makes a timely call, she will have to provide certain contact information (and may have to provide certain market research information) and will then receive a response back (e.g. text message or email) with certain additional promotional messages and confirmation that the viewer is eligible for the discount if used within a prescribed period, e.g., 30 days. Additionally or alternatively, the commercial could tell the viewer that she would receive a 50% instant discount if she went online and purchased certain furniture online within 5-10 minutes from the time the commercial is shown and a discount code is entered. Again, the system can validate that the purchase is made during the defined period after the commercial airs.

### Example 4

### Influencing Content

In this example, the Walt Company, which specializes in marketing to children creates and interactive television campaign. When the company airs a specified movie or television show, its viewers can influence certain content of the show. For example, in a show featuring popular character Anna Wyoming, the viewers can vote on two outfits during the period when she is deciding what to where (and the commercial break before she makes her decision) by sending their choice as text message or calling a phone number from the viewer's phone that corresponds to the outfit choices. A system of the type described herein automatically receives, validates, and tallies the votes. Scenes for both possible outcomes are prefilmed and the system sends instructions to the broadcaster to broadcasts the scene which contains the winning outfit. The system can also provide interactive content to one or more devices associated with the viewer prior to the vote (e.g., information regarding the designers of the outfit, etc.).

### Example 5

### Focus Groups

In this example, viewers of a television program serve as remote focus groups by responding in real time or near real time to questions transmitted to their phones or through mobile applications or through the Internet as the program broadcast progresses. A system of the type described herein monitors the broadcast in real time or near real time and transmits questions related to events occurring in the program. As described above, the viewers can be rewarded for provided their answers during a defined period after each event, and the system can receive and validate the viewer answers and facilitate the awards program.

### Example 6

### Interactive Supplemental Content

In this example, when a spy movie is broadcast, a system of the type described herein operates to provide real time supplemental content. The system monitors the broadcast and determines in real time or near real time information about the current scene (e.g., the characters present, spy gadgets being used, etc.). This information is used to provide real time supplemental content via a website or a mobile application, (e.g., character dossiers and background stories for the characters in the scene, technical schematics for the spy gadgets in use, etc.)

### Example 7

### Content Access

In this example, a game maker ABC Gaming company (“ABC”) creates a game utilizing the technology described herein. Viewers play the game by correctly identifying and/or interacting with specific scenes while watching these shows in real time on any television, thereby accumulating and/or entering to win points, prizes, rewards, recognitions and/or virtual goods or currencies or other content or access, by correctly identifying and/or interacting with specific scenes from various shows, movies, commercials etc. For example, a viewer plays the game by sending a specified text or email message or calls a phone number from the viewer's phone or enters a text into or clicks a link or button on a mobile application or into an Internet site during a defined time period (e.g. within 1 minute) whenever a scene or an item, scenery or event shown in a scene is broadcast and viewed by the viewer. If the viewer correctly and timely enters the specified message or timely calls the specified telephone number, the viewer receives points, prizes, rewards, recognitions and/or virtual goods or currencies or other content or access and can win discounts or prizes. In addition, by timely and correctly entering the specified message or timely calling the specified telephone number the viewer can thereby become eligible to participate in other contests or game activities, such as for example answering trivia question(s) relating to the show, for additional points, prizes, rewards, recognitions and/or virtual goods or currencies or other content or access. The viewer may be informed of the scenes to which the viewer will have to timely react during or ahead of the game. In addition or alternatively, the viewer may be prompted by the game to respond to questions or participate in contests or other game activities when a specified scene or media sequence is broadcast. The contest or other game activity may relate to one or more certain scenes or any item, scenery or event shown in a scene, which are questions or contests are displayed to the viewer after a specific scene is broadcast. The gaming activity or contest may relate to the scene as it is shown or that was just shown (e.g., the viewer is asked to answer the question “who just entered the room?”) or to other content of the show (e.g., the viewer is asked to answer the question “how many times has the main character cried since the last commercial break”). The system described above may store reference descriptors corresponding to the scenes of the show at issue. As described above, the system will compare descriptors generated from a broadcast media sequence to these reference descriptors to identify when the relevant scene is broadcast. This information is then used to determine whether the viewer reacted timely and/or to trigger the gaming activity or contest or other interactivity with the viewer.

### Example 8

### Access Rights Reward

In this example, a professional sports league creates a promotion featuring an access rights type reward, implemented using the systems and techniques described herein. Viewers are prompted to respond (e.g., by text message including certain identifying information) within a defined time period from the broadcast of the league's commercials on a cable sports news channel. If a viewer responds in a timely fashion, the viewer is given access to a limited access cable channel on the viewer's cable television system (e.g., a channel showing out of market games played by the league's teams). The system implements the promotion automatically. As described above, the system validates that the viewer's response is timely and contains the requested identifying information. If this is the case, the system instructs the viewer's cable provider (using the identifying information received from the viewer) to grant access to the channel for a period of time and, if necessary, arranges to pay the cable provider for this access.

### Exemplary Media Sequence Comparison Techniques

The systems for providing interactivity with a media broadcast as described above require the comparison of a broadcast media sequence with one or more reference sequences. The following details various systems and techniques which may be utilized to carry out such comparisons. In various embodiments, all or portions of the devices and systems described below may be included in system 100 of FIG. 1.

Additional approaches to media sequence comparison may be found in International Patent Application Serial No. PCT/US2008/060164, filed Apr. 13, 2008 and International Patent Application Serial No. PCT/IB2009/005407, filed Feb. 28, 2009, International Patent Application Serial No. PCT/US2009/040361, filed Apr. 13, 2009, and International Patent Application Serial No. PCT/US2009/054066, filed Aug. 17, 2009, each of which was incorporated by reference above.

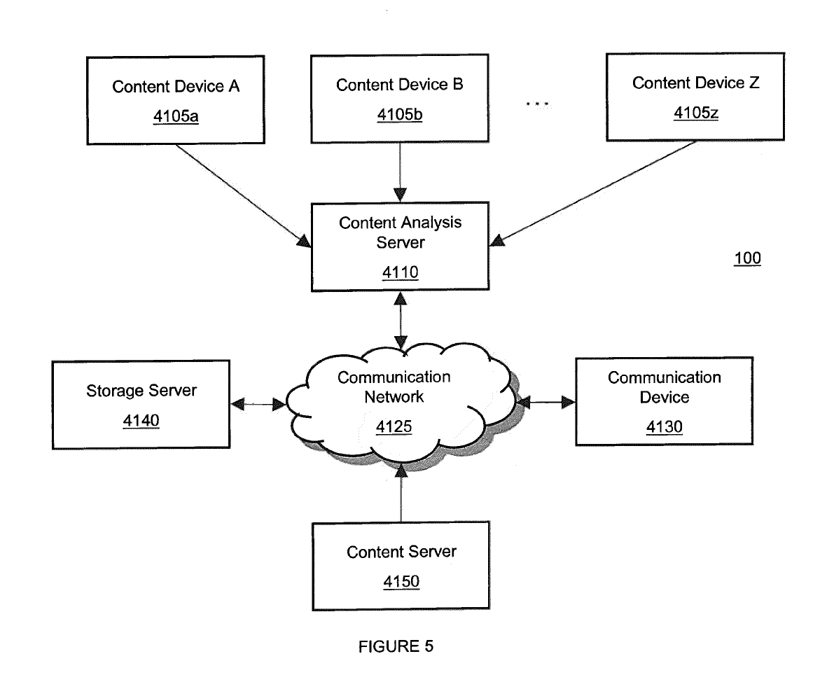

FIG. 5 is a functional block diagram of an exemplary system 4100. The system 4100 receives content from, one or more content devices A 4105a, B 4105b through Z 4105z (hereinafter referred to as content devices 105). For example, one or more these content devices may correspond to broadcast source. The system 4100 includes a content analyzer, such as a content analysis server 4110, a communications network 4125, a communication device 4130, a storage server 4140, and a content server 4150. The devices and/or servers communicate with each other via the communication network 4125 and/or via connections between the devices and/or servers (e.g., direct connection, indirect connection, etc.).

The content analysis server 4110 requests and/or receives multimedia streams from one or more of the content devices 4105 (e.g., digital video disc device, signal acquisition device, satellite reception device, cable reception box, etc.), the storage server 4140 (e.g., storage area network server, network attached storage server, etc.), the content server 4150 (e.g., internet based multimedia server, streaming multimedia server, etc.), and/or any other server or device that can store a multimedia stream (e.g., cell phone, camera, etc.). The content analysis server 4110 identifies one or more frame sequences for each multimedia stream. The content analysis server 4110 generates a respective fingerprint for each of the one or more frame sequences for each multimedia stream. The content analysis server 4110 compares the fingerprints of one or more frame sequences between each multimedia stream. The content analysis server 4110 generates a report (e.g., written report, graphical report, text message report, alarm, graphical message, etc.) of the similar and/or different frame sequences between the multimedia streams.

In other examples, the content analysis server 4110 generates a fingerprint for each frame in each multimedia stream. The content analysis server 4110 can generate the fingerprint for each frame sequence (e.g., group of frames, direct sequence of frames, indirect sequence of frames, etc.) for each multimedia stream based on the fingerprint from each frame in the frame sequence and/or any other information associated with the frame sequence (e.g., video content, audio content, metadata, etc.).

In some examples, the content analysis server 4110 generates the frame sequences for each multimedia stream based on information about each frame (e.g., video content, audio content, metadata, fingerprint, etc.).

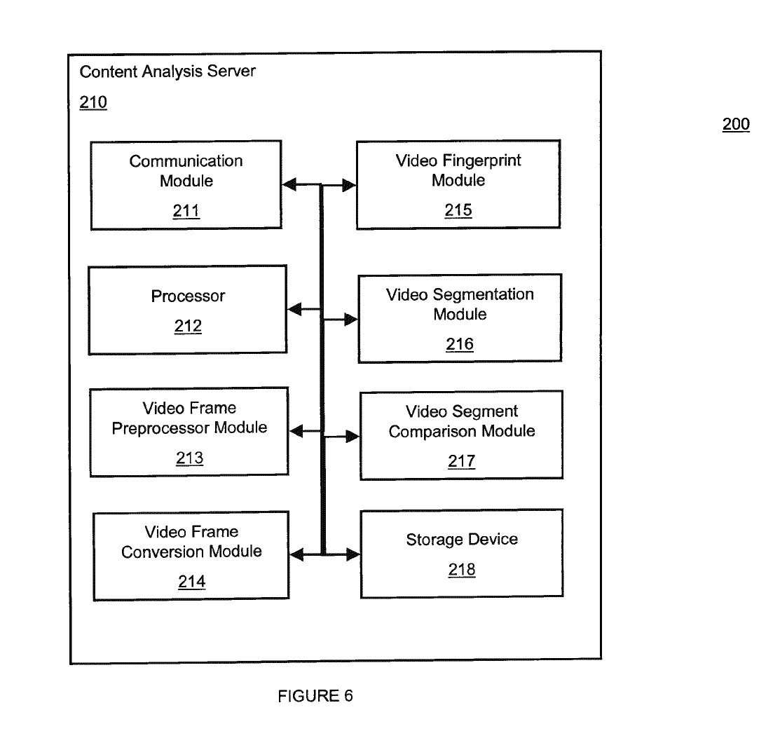

FIG. 6 illustrates a functional block diagram of an exemplary content analysis server 210 in a system 200. The content analysis server 210 includes a communication module 211, a processor 212, a video frame preprocessor module 213, a video frame conversion module 214, a video fingerprint module 215, a video segmentation module 216, a video segment conversion module 217, and a storage device 218.

The communication module 211 receives information for and/or transmits information from the content analysis server 210. The processor 212 processes requests for comparison of multimedia streams (e.g., request from a viewer, automated request from a schedule server, etc.) and instructs the communication module 211 to request and/or receive multimedia streams. The video frame preprocessor module 213 preprocesses multimedia streams (e.g., remove black border, insert stable borders, resize, reduce, selects key frame, groups frames together, etc.). The video frame conversion module 214 converts the multimedia streams (e.g., luminance normalization, RGB to Color9, etc.). The video fingerprint module 215 generates a fingerprint for each key frame selection (e.g., each frame is its own key frame selection, a group of frames have a key frame selection, etc.) in a multimedia stream. The video segmentation module 216 segments frame sequences for each multimedia stream together based on the fingerprints for each key frame selection. The video segment comparison module 217 compares the frame sequences for multimedia streams to identify similar frame sequences between the multimedia streams (e.g., by comparing the fingerprints of each key frame selection of the frame sequences, by comparing the fingerprints of each frame in the frame sequences, etc.). The storage device 218 stores a request, a multimedia stream, a fingerprint, a frame selection, a frame sequence, a comparison of the frame sequences, and/or any other information associated with the comparison of frame sequences.

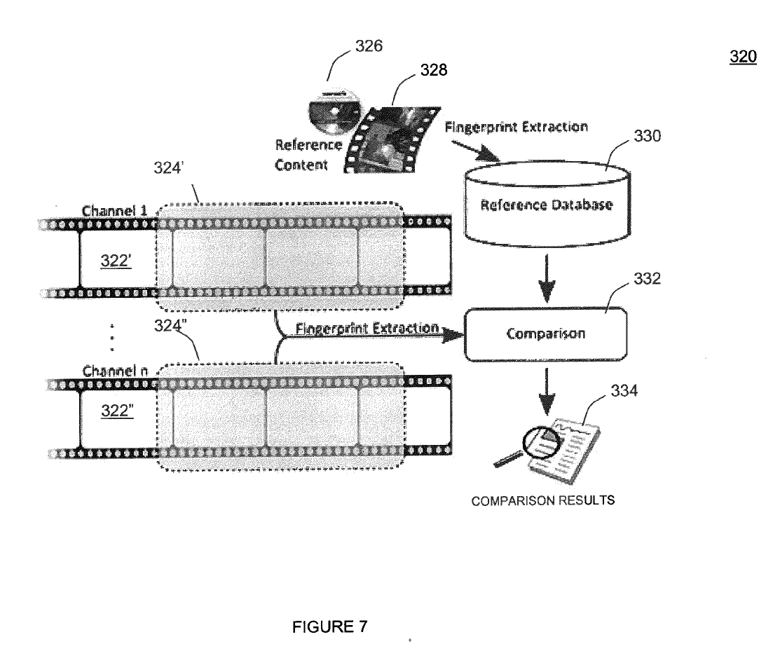

FIG. 7 illustrates an exemplary block diagram of an exemplary multi-channel video comparing process 320 in the system 4100 of FIG. 5. The content analysis server 4110 receives one or more channels 1 322′ through n 322″ (generally referred to as channel 322) and reference content 326. The content analysis server 4110 identifies groups of similar frames 328 of the reference content 326 and generates a representative fingerprint for each group. In some embodiments, the content analysis server 4110 includes a reference database 330 to store the one or more fingerprints associated with the reference content 326. The content analysis server 4110 identifies groups of similar frames 324′ and 324″ (generally referred to as group 324) for the multimedia stream on each channel 322. The content analysis server 4110 generates a representative fingerprint for each group 324 in each multimedia stream. The content analysis server 4110 compares (332) the representative fingerprint for the groups 324 of each multimedia stream with the reference fingerprints determined from the reference content 326, as may be stored in the reference database 330. The content analysis server 4110 generates (334) results based on the comparison of the fingerprints. In some embodiments, the results include statistics determined from the comparison (e.g., frame similarity ratio, frame group similarity ratio, etc.).

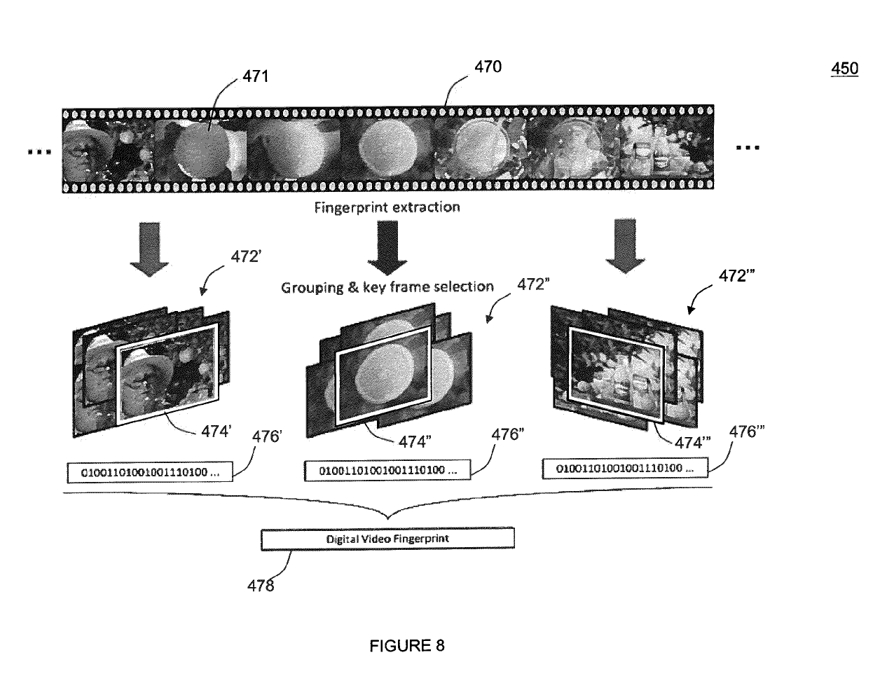

FIG. 8 illustrates an exemplary flow diagram 450 of a generation of a digital video fingerprint. The content analysis units fetch the recorded data chunks (e.g., multimedia content) from the signal buffer units directly and extract fingerprints prior to the analysis. The content analysis server 4110 of FIG. 5 receives one or more video (and more generally audiovisual) clips or segments 470, each including a respective sequence of image frames 471. Video image frames are highly redundant, with groups frames varying from each other according to different shots of the video segment 470. In the exemplary video segment 470, sampled frames of the video segment are grouped according to shot: a first shot 472′, a second shot 472″, and a third shot 472′″. A representative frame, also referred to as a key frame 474′, 474″, 474′″ (generally 474) is selected for each of the different shots 472′, 472″, 472′″ (generally 472). The content analysis server 4100 determines a respective digital signature 476′, 476″, 476′″ (generally 476) for each of the different key frames 474. The group of digital signatures 476 for the key frames 474 together represent a digital video fingerprint 478 of the exemplary video segment 470.

In some examples, a fingerprint is also referred to as a descriptor. Each fingerprint can be a representation of a frame and/or a group of frames. The fingerprint can be derived from the content of the frame (e.g., function of the colors and/or intensity of an image, derivative of the parts of an image, addition of all intensity value, average of color values, mode of luminance value, spatial frequency value). The fingerprint can be an integer (e.g., 345, 523) and/or a combination of numbers, such as a matrix or vector (e.g., [a, b], [x, y, z]). For example, the fingerprint is a vector defined by [x, y, z] where x is luminance, y is chrominance, and z is spatial frequency for the frame.

In some embodiments, shots are differentiated according to fingerprint values. For example in a vector space, fingerprints determined from frames of the same shot will differ from fingerprints of neighboring frames of the same shot by a relatively small distance. In a transition to a different shot, the fingerprints of a next group of frames differ by a greater distance. Thus, shots can be distinguished according to their fingerprints differing by more than some threshold value.

Thus, fingerprints determined from frames of a first shot 472′ can be used to group or otherwise identify those frames as being related to the first shot. Similarly, fingerprints of subsequence shots can be used to group or otherwise identify subsequence shots 472″, 472′″. A representative frame, or key frame 474′, 474″, 474′″ can be selected for each shot 472. In some embodiments, the key frame is statistically selected from the fingerprints of the group of frames in the same shot (e.g., an average or centroid).

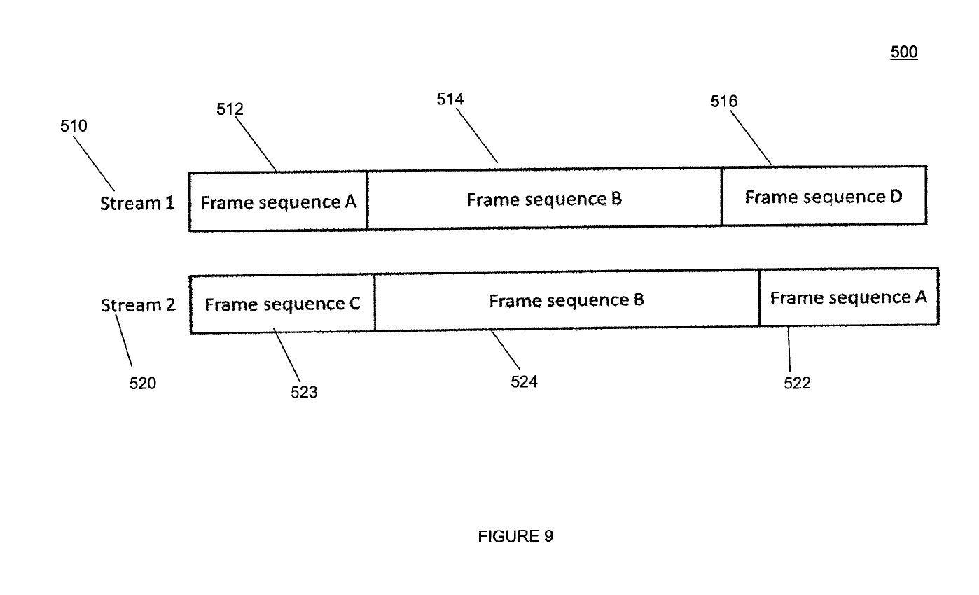

FIG. 9 illustrates an exemplary result 500 of a comparison of two video streams 510 and 520 by the content analysis server 4110 of FIG. 5. The content analysis server 4110 splits each of the video streams 510 and 520 into frame sequences 512, 514, 516, 523, 524, and 522, respectively, based on key frames. The content analysis server 4110 compares the frame sequences to find similar frame sequences between the video streams 510 and 520. Stream 1 510 includes frame sequences A 512, B 514, and C 516. Stream 2 520 includes frame sequences C 523, B 524, and A 522. The content analysis server matches frame sequence B 514 in stream 1 510 to the frame sequence B 524 in stream 2 520.

For example, the communication module 211 of FIG. 6 receives a request from a viewer to compare two digital video discs (DVD). The first DVD is the European version of a movie titled “All Dogs Love the Park.” The second DVD is the United States version of the movie titled “All Dogs Love the Park.” The processor 212 processes the request from the viewer and instructs the communication module 211 to request and/or receive the multimedia streams from the two DVDs (i.e., transmitting a play command to the DVD player devices that have the two DVDs). The video frame preprocessor module 213 preprocesses the two multimedia streams (e.g., remove black border, insert stable borders, resize, reduce, identifies a key frame selection, etc.). The video frame conversion module 214 converts the two multimedia streams (e.g., luminance normalization, RGB to Color9, etc.). The video fingerprint module 215 generates a fingerprint for each key frame selection (e.g., each frame is its own key frame selection, a group of frames have a key frame selection, etc.) in the two multimedia streams. The video segmentation module 216 segments the frame sequences for each multimedia stream. The video segment comparison module 217 compares a signature for each frame sequence for the multimedia stream to identify similar frame sequences. Table 1 illustrates an exemplary comparison process for the two multimedia streams illustrated in FIG. 9.

TABLE 1
Exemplary Comparison Process

| Multimedia Stream 1 510 | Multimedia Stream 2 520 | Result |
|---|---|---|
| Frame Sequence A 512 | Frame Sequence C 523 | Different |
| Frame Sequence A 512 | Frame Sequence B 524 | Different |
| Frame Sequence A 512 | Frame Sequence A 522 | Similar |
| Frame Sequence B 514 | Frame Sequence C 523 | Different |
| Frame Sequence B 514 | Frame Sequence B 524 | Similar |
| Frame Sequence B 514 | Frame Sequence A 522 | Different |
| Frame Sequence D 516 | Frame Sequence C 523 | Different |
| Frame Sequence D 516 | Frame Sequence B 524 | Different |
| Frame Sequence D 516 | Frame Sequence A 522 | Different |

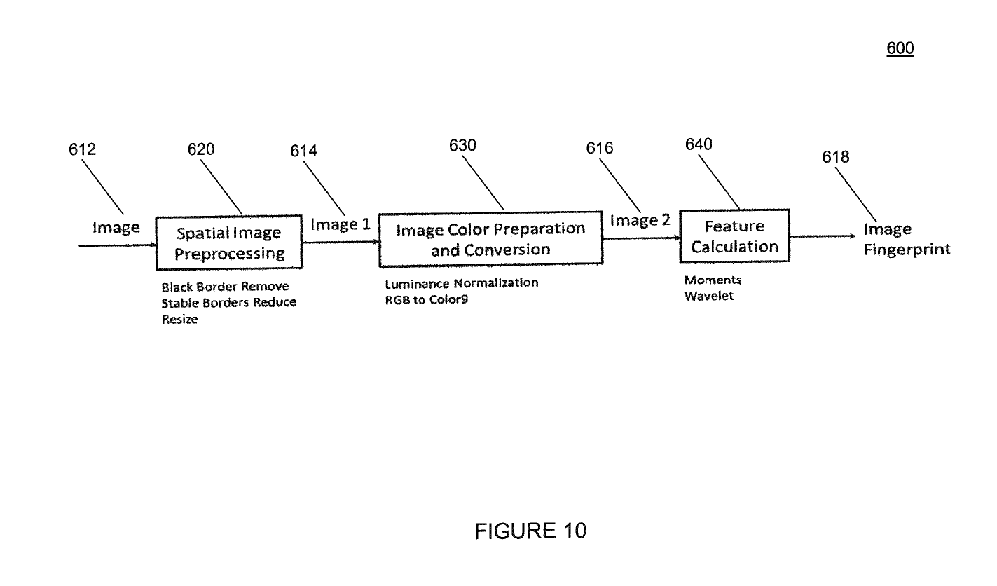

FIG. 10 illustrates an exemplary flow chart 600 of a generation of a fingerprint for an image 612 by the content analysis server 210 of FIG. 6. The communication module 211 receives the image 612 and communicates the image 612 to the video frame preprocessor module 213. The video frame preprocessor module 213 preprocesses (620) (e.g., spatial image preprocessing) the image to form a preprocessed image 614. The video frame conversion module 214 converts (630) (e.g., image color preparation and conversation) the preprocessed image 614 to form a converted image 616. The video fingerprint module 215 generates (640) (e.g., feature calculation) an image fingerprint 618 of the converted image 616.

In some examples, the image is a single video frame. The content analysis server 210 can generate the fingerprint 618 for every frame in a multimedia stream and/or every key frame in a group of frames. In other words, the image 612 can be a key frame for a group of frames. In some embodiments, the content analysis server 210 takes advantage of a high level of redundancy and generates fingerprints for every n^{th} frame (e.g., n=2).

In other examples, the fingerprint 618 is also referred to as a descriptor. Each multimedia stream has an associated list of descriptors that are compared by the content analysis server 210. Each descriptor can include a multi-level visual fingerprint that represents the visual information of a video frame and/or a group of video frames.

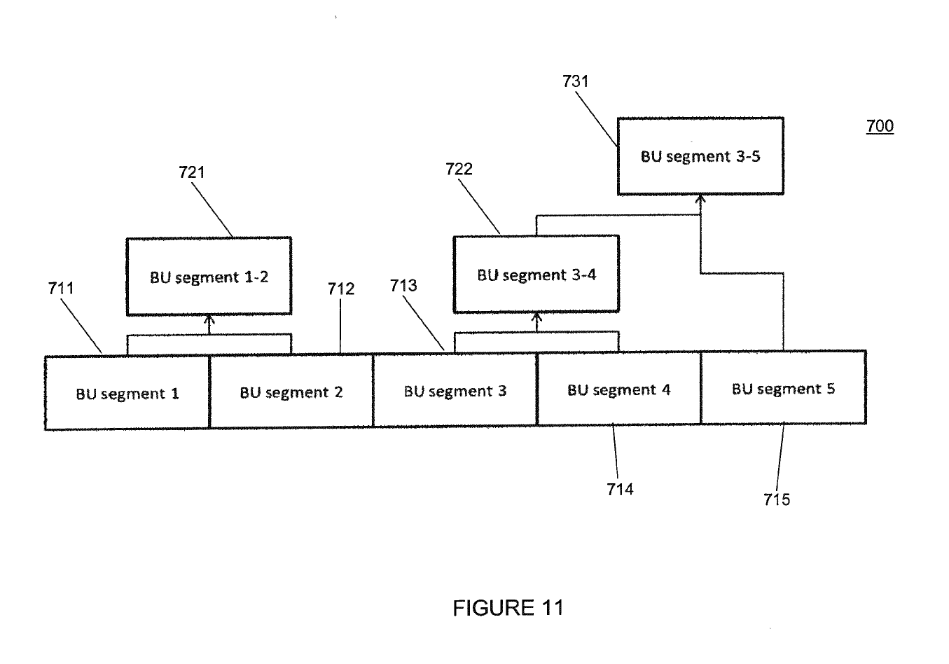

FIG. 11 illustrates an exemplary block process diagram 700 of a grouping of frames (also referred to as segments) by the content analysis server 210 of FIG. 2. Each segment 1 711, 2 712, 3 713, 4 714, and 5 715 includes a fingerprint for the segment. Other indicia related to the segment can be associated with the fingerprint, such as a frame number, a reference time, a segment start reference, stop reference, and/or segment length. The video segmentation module 216 compares the fingerprints for the adjacent segments to each other (e.g., fingerprint for segment 1 711 compared to fingerprint for segment 2 712, etc.). If the difference between the fingerprints is below a predetermined and/or a dynamically set segmentation threshold, the video segmentation module 216 merges the adjacent segments. If the difference between the fingerprints is at or above the predetermined and/or a dynamically set segmentation threshold, the video segmentation module 216 does not merge the adjacent segments.

In the example, the video segmentation module 216 compares the fingerprints for segment 1 711 and 2 712 and merges the two segments into segment 1-2 721 based on the difference between the fingerprints of the two segments being less than a threshold value. The video segmentation module 216 compares the fingerprint for segments 2 712 and 3 713 and does not merge the segments be cause the difference between the two fingerprints is greater than the threshold value. The video segmentation module 216 compares the fingerprints for segment 3 713 and 4 714 and merges the two segments into segment 3-4 722 based on the difference between the fingerprints of the two segments. The video segmentation module 216 compares the fingerprints for segment 3-4 722 and 5 715 and merges the two segments into segment 3-5 731 based on the difference between the fingerprints of the two segments. The video segmentation module 216 can further compare the fingerprints for the other adjacent segments (e.g., segment 2 712 to segment 3 713, segment 1-2 721 to segment 3 713, etc.). The video segmentation module 216 completes the merging process when no further fingerprint comparisons are below the segmentation threshold. Thus, selection of a comparison or difference threshold for the comparisons can be used to control the storage and/or processing requirements.

In other examples, each segment 1 711, 2 712, 3 713, 4 714, and 5 715 includes a fingerprint for a key frame in a group of frames and/or a link to the group of frames. In some examples, each segment 1 711, 2 712, 3 713, 4 714, and 5 715 includes a fingerprint for a key frame in a group of frames and/or the group of frames.

In some examples, the video segment comparison module 217 identifies similar segments (e.g., merged segments, individual segments, segments grouped by time, etc.). The identification of the similar segments can include one or more of the following identification processes: (i) brute-force process (i.e., compare every segment with every other segment); (ii) adaptive windowing process; and (iii) clustering process.

FIG. 8 illustrates an exemplary block diagram of a brute-force comparison process 800 via the content analysis server 210 of FIG. 6. The comparison process 800 is comparing segments of stream 1 810 with segments of stream 2 820. The video segment comparison module 217 compares Segment 1.1 811 with each of the segments of stream 2 820 as illustrated in Table 2. The segments are similar if the difference between the signatures of the compared segments is less than a comparison threshold (e.g., difference within a range 3<difference <−3, absolute difference−|difference├, etc.). The comparison threshold for the segments illustrated in Table 2 is four. The comparison threshold can be predetermined and/or dynamically configured (e.g., a percentage of the total number of segments in a stream, ratio of segments between the streams, etc.).

TABLE 2
Exemplary Comparison Process

| Multimedia | | Multimedia | | Absolute | |
|---|---|---|---|---|---|
| Stream 1 810 | Signature | Stream 2 820 | Signature | Difference | Result |
| Segment 1.1 811 | 59 | Segment 2.1 821 | 56 | 3 | Similar |
| Segment 1.1 811 | 59 | Segment 2.2 822 | 75 | 6 | Different |
| Segment 1.1 811 | 59 | Segment 2.3 823 | 57 | 2 | Similar |
| Segment 1.1 811 | 59 | Segment 2.4 824 | 60 | 1 | Similar |
| Segment 1.1 811 | 59 | Segment 2.5 825 | 32 | 27 | Different |

The video segment comparison module 217 adds the pair of similar segments and the difference between the signatures to a similar_segment_list as illustrated in Table 3.

TABLE 3
Exemplary Similar_Segment_List

| Segment | Segment | Absolute Difference |
|---|---|---|
| Segment 1.1 811 | Segment 2.1 821 | 3 |
| Segment 1.1 811 | Segment 2.3 823 | 2 |
| Segment 1.1 811 | Segment 2.4 824 | 1 |

FIG. 9 illustrates an exemplary block diagram of an adaptive window comparison process 900 via the content analysis server 210 of FIG. 2. The adaptive window comparison process 900 analyzes stream 1 910 and stream 2 920. The stream 1 910 includes segment 1.1 911, and the stream 2 920 includes segments 2.1 921, 2.2 922, 2.3 923, 2.4 924, and 2.5 925. The video segment comparison module 217 compares the segment 1.1 911 in the stream 1 910 to each segment in the stream 2 920 that falls within an adaptive window 930. In other words, the segment comparison module 217 compares segment 1.1 911 to the segments 2.2 922, 2.3 923, and 2.4 924. The video segment comparison module 217 adds the pair of similar segments and the difference between the signatures to the similar_segment_list. For example, the adaptive window comparison process 900 is utilized for multimedia streams over thirty minutes in length and the brute-force comparison process 800 is utilized for multimedia streams under thirty minutes in length. As another example, the adaptive window comparison process 900 is utilized for multimedia streams over five minutes in length and the brute-force comparison process 800 is utilized for multimedia streams under five minutes in length.

In other embodiments, the adaptive window 930 can grow and/or shrink based on the matches and/or other information associated with the multimedia streams (e.g., size, content type, etc.). For example, if the video segment comparison module 217 does not identify any matches or below a match threshold number for a segment within the adaptive window 930, the size of the adaptive window 930 can be increased by a predetermined size (e.g., from the size of three to the size of five, from the size of ten to the size of twenty, etc.) and/or a dynamically generated size (e.g., percentage of total number of segments, ratio of the number of segments in each stream, etc.). After the video segment comparison module 217 identifies the match threshold number and/or exceeds a maximum size for the adaptive window 930, the size of the adaptive window 930 can be reset to the initial size and/or increased based on the size of the adaptive window at the time of the match.

In some embodiments, the initial size of the adaptive window is predetermined (e.g., five hundred segments, three segments on either side of the corresponding time in the multimedia streams, five segments on either side of the respective location with respect to the last match in the multimedia streams, etc.) and/or dynamically generated (e.g., ⅓ length of multimedia content, ratio based on the number of segments in each multimedia stream, percentage of segments in the first multimedia stream, etc.). The initial start location for the adaptive window can be predetermined (e.g., same time in both multimedia streams, same frame number for the key frame, etc.) and/or dynamically generated (e.g., percentage size match of the respective segments, respective frame locations from the last match, etc.).

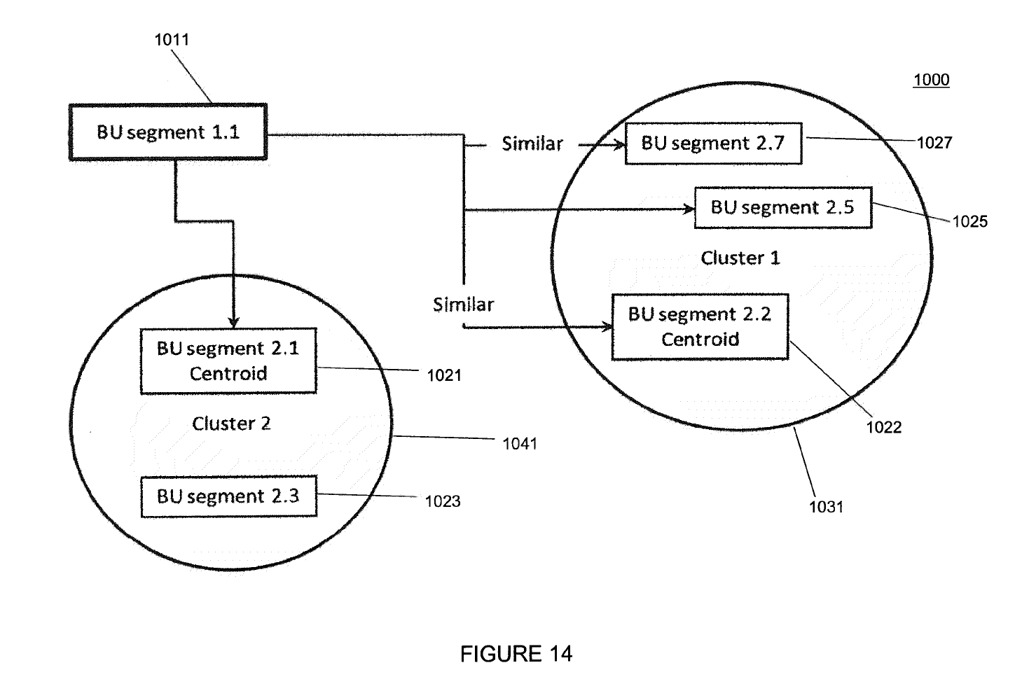

FIG. 14 illustrates an exemplary block diagram of a clustering comparison process 1000 via the content analysis server 210 of FIG. 6. The adaptive window comparison process 1000 analyzes stream 1 and stream 2. The stream 1 includes segment 1.1 1011, and the stream 2 includes segments 2.1 1021, 2.2 1022, 2.3 1023, 2.5 1025, and 275 1027. The video segment comparison module 217 clusters the segments of stream 2 together, cluster 1 1031 and cluster 2 1041 according to their fingerprints. For each cluster, the video segment comparison module 217 identifies a representative segment, such as that segment having a fingerprint that corresponds to a centroid of the cluster of fingerprints for that cluster. The centroid for cluster 1 1031 is segment 2.2 1022, the centroid for cluster 2 1041 is segment 2.1 1021.

The video segment comparison module 217 compares the segment 1.1 1011 with the centroid segments 2.1 1021 and 2.2 1022 for each cluster 1 1031 and 2 1041, respectively. If a centroid segment 2.1 1021 or 2.2 1022 is similar to the segment 1.1 1011, the video segment comparison module 217 compares every segment in the cluster of the similar centroid segment with the segment 1.1 1011. The video segment comparison module 217 adds any pairs of similar segments and the difference between the signatures to the similar_segment_list.

In some embodiments, one or more of the different statistics can be used. For example, the brute-force comparison process 800 is utilized for multimedia streams under thirty minutes in length, the adaptive window comparison process 900 is utilized for multimedia streams between thirty-sixty minutes in length, and the clustering comparison process 1000 is used for multimedia streams over sixty minutes in length.

Although the clustering comparison process 1000 as described in FIG. 10 utilizes a centroid, the clustering process 1000 can utilize any type of statistical function to identify a representative segment for comparison for the cluster (e.g., average, mean, median, histogram, moment, variance, quartiles, etc.). In some embodiments, the video segmentation module 216 clusters segments together by determining the difference between the fingerprints of the segments for a multimedia stream. For the clustering process, all or part of the segments in a multimedia stream can be analyzed (e.g., brute-force analysis, adaptive window analysis, etc.).

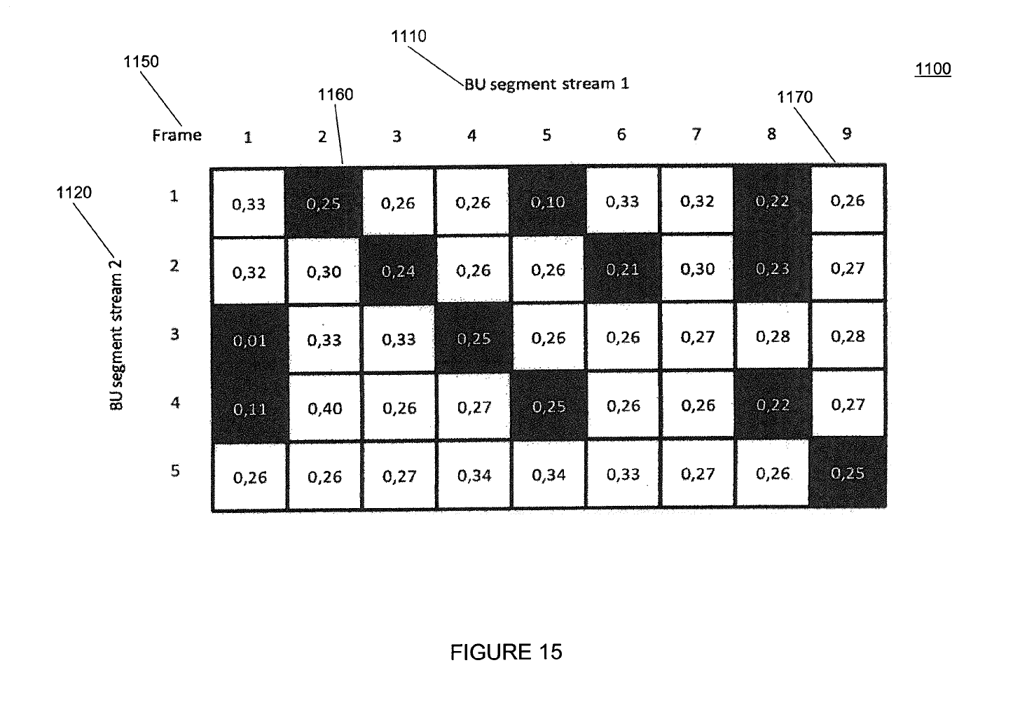

FIG. 15 illustrates an exemplary block diagram 1100 of an identification of similar frame sequences via the content analysis server 210 of FIG. 6. The block diagram 1100 illustrates a difference matrix generated by the pairs of similar segments and the difference between the signatures in the similar_segment_list. The block diagram 100 depicts frames 1-9 1150 (i.e., nine frames) of segment stream 1 1110 and frames 1-5 1120 (i.e., five frames) of segment stream 2 1120. In some examples, the frames in the difference matrix are key frames for an individual frame and/or a group of frames.

The video segment comparison 217 can generate the difference matrix based on the similar_segment_list. As illustrated in FIG. 11, if the difference between the two frames is below a detailed comparison threshold (in this example, 0.26), the block is black (e.g., 1160). Furthermore, if the difference between the two frames is not below the detailed threshold, the block is white (e.g., 1170).

The video segment comparison module 217 can analyze the diagonals of the difference matrix to detect a sequence of similar frames. The video segment comparison module 217 can find the longest diagonal of adjacent similar frames (in this example, the diagonal (1,2)-(4,5) is the longest) and/or find the diagonal of adjacent similar frames with the smallest average difference (in this example, the diagonal (1,5)-(2,6) has the smallest average difference) to identify a set of similar frame sequences. This comparison process can utilize one or both of these calculations to detect the best sequence of similar frames (e.g., use both and average the length times the average and take the highest result to identify the best sequence of similar frames). This comparison process can be repeated by the video segment comparison module 217 until each segment of stream 1 is compared to its similar segments of stream 2.

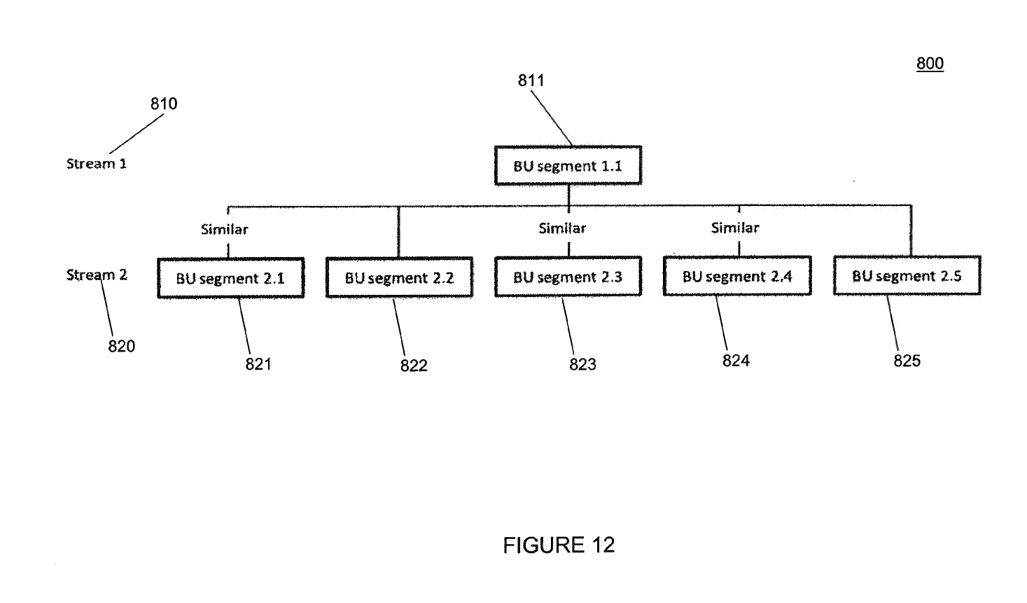

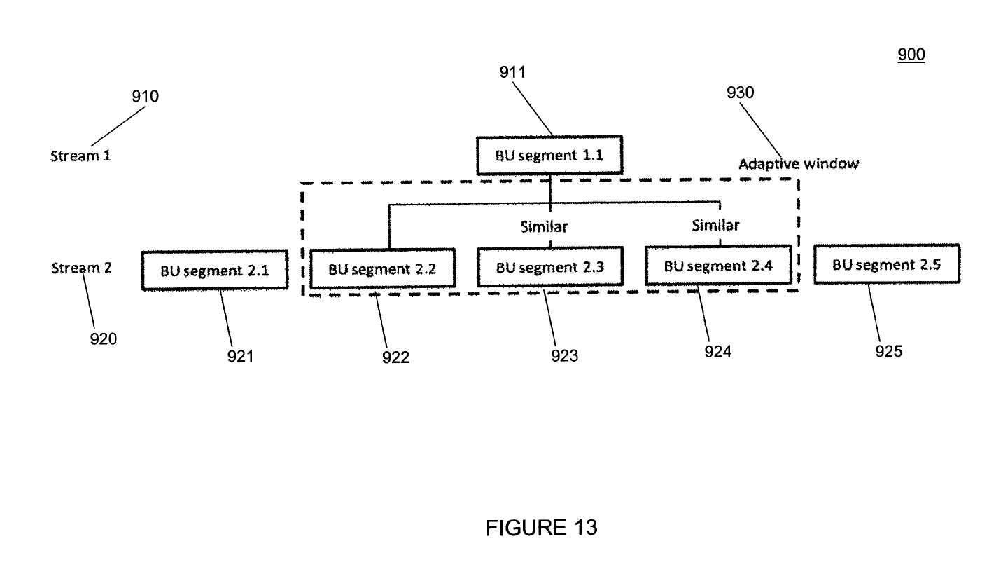

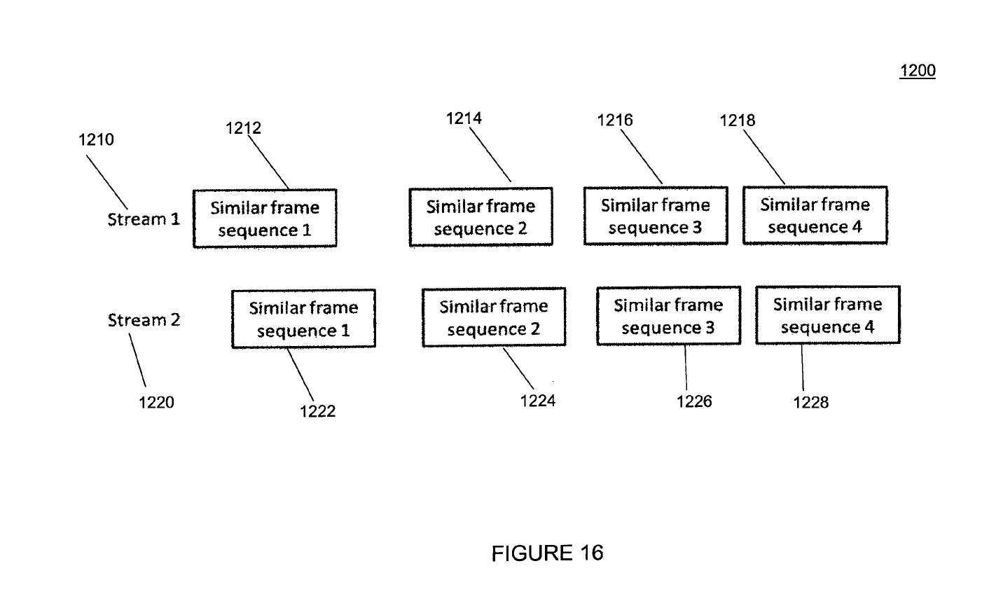

FIG. 16 illustrates an exemplary block diagram 1200 of similar frame sequences identified by the content analysis server 210 of FIG. 6. Based on the analysis of the diagonals, the video segment comparison module 217 identifies a set of similar frame sequences for stream 1 1210 and stream 2 1220. The stream 1 1210 includes frame sequences 1 1212, 2 1214, 3 1216, and 4 1218 that are respectively similar to frame sequences 1 1222, 2 1224, 3 1226, and 4 1228 of stream 2 1220. As illustrated in FIG. 12, the streams 1 1210 and 2 1220 can include unmatched or otherwise dissimilar frame sequences (i.e., space between the similar frame sequences).

In some embodiments, the video segment comparison module 217 identifies similar frame sequences for unmatched frame sequences, if any. The unmatched frame sequences can also be referred to as holes. The identification of the similar frame sequences to unmatched frame sequence can be based on a hold comparison threshold that is predetermined and/or dynamically generated. The video segment comparison module 217 can repeat the identification of similar frame sequences for unmatched frame sequences until all unmatched frame sequences are matched and/or can identify the unmatched frame sequences as unmatched (i.e., no match is found). The identification of the similar segments can include one or more of the following identification processes: (i) brute-force process; (ii) adaptive windowing process; (iii) extension process; and (iv) hole matching process.

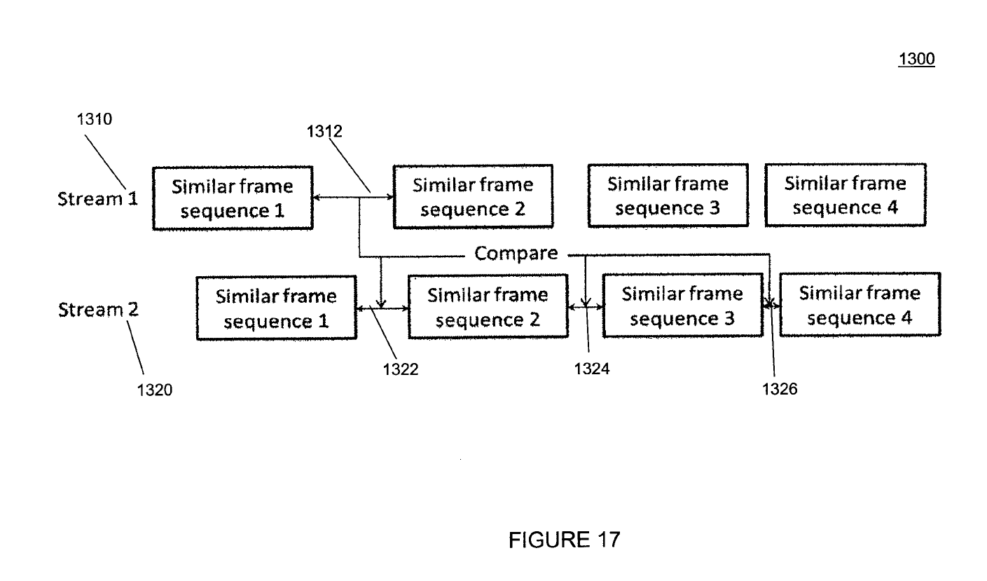

FIG. 17 illustrates an exemplary block diagram of a brute force identification process 1300 via the content analysis server 210 of FIG. 6. The brute force identification process 1300 analyzes streams 1 1310 and 2 1320. The stream 1 1310 includes hole 1312, and the stream 2 1320 includes holes 1322, 1324, and 1326. For the identified hole 1312 in stream 1 1310, the video segment comparison module 217 compares the hole 1312 with all of the holes in stream 2 1320. In other words, the hole 1312 is compared to the holes 1322, 1324, and 1326. The video segment comparison module 217 can compare the holes by determining the difference between the signatures for the compares hold, and determining if the difference is below the hold comparison threshold. The video segment comparison module 217 can match the holes with the best result (e.g., lowest difference between the signatures, lowest difference between frame numbers, etc.).

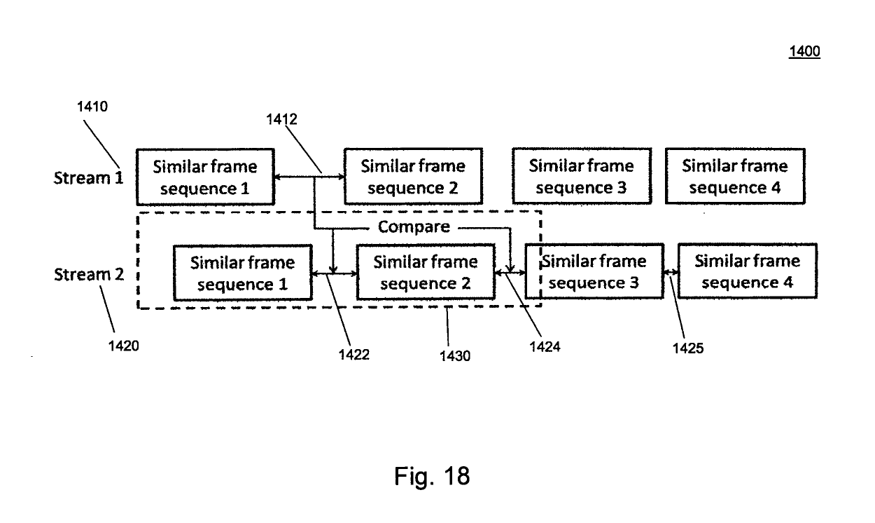

FIG. 18 illustrates an exemplary block diagram of an adaptive window identification process 1400 via the content analysis server 210 of FIG. 6. The adaptive window identification process 1400 analyzes streams 1 1410 and 2 1420. The stream 1 1410 includes a target hole 1412, and the stream 2 1420 includes holes 1422, 1424 and 1425, of which holes 1422 and 1424 fall in the adaptive window 1430. For the identified target hole 1412 in stream 1 1410, the video segment comparison module 217 compares the hole 1412 with all of the holes in stream 2 1420 that fall within the adaptive window 1430. In other words, the hole 1412 is compared to the holes 1422 and 1424. The video segment comparison module 217 can compare the holes by determining the difference between the signatures for the compares hold, and determining if the difference is below the hold comparison threshold. The video segment comparison module 217 can match the holes with the best result (e.g., lowest difference between the signatures, lowest difference between frame numbers, etc.). The initial size of the adaptive window 1430 can be predetermined and/or dynamically generated as described herein. The size of the adaptive window 1430 can be modified as described herein.

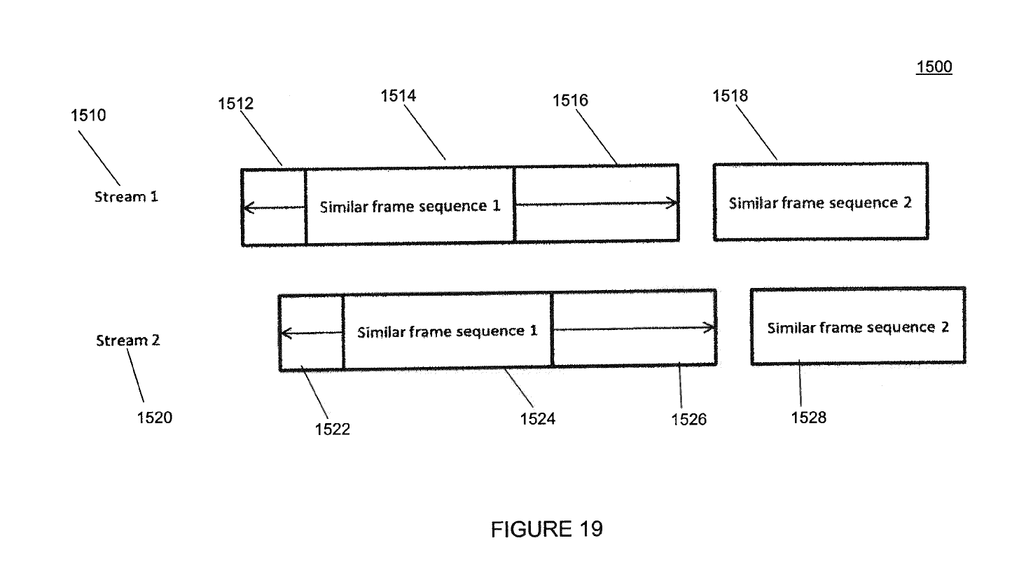

FIG. 19 illustrates an exemplary block diagram of an extension identification process 1500 via the content analysis server 210 of FIG. 6. The extension identification process 1500 analyzes streams 1 1510 and 2 1520. The stream 1 1510 includes similar frame sequences 1 1514 and 2 1518 and extensions 1512 and 1516, and the stream 2 1520 includes similar frame sequences 1 1524 and 2 1528 and extensions 1522 and 1526. The video segment comparison module 217 can extend similar frame sequences (in this example, similar frame sequences 1 1514 and 1 1524) to the left and/or to the right of their existing start and/or stop locations.

The extension of the similar frame sequences can be based on the difference of the signatures for the extended frames and the hole comparison threshold (e.g., the difference of the signatures for each extended frame is less than the hole comparison threshold). As illustrated, the similar frame sequence 1 1514 and 1 1524 are extended to the left 1512 and 1522 and to the right 1516 and 1526, respectively. In other words, the video segment comparison module 217 can determine the difference in the signatures for each frame to the right and/or to the left of the respective similar frame sequences. If the difference is less than the hole comparison threshold, the video segment comparison module 217 extends the similar frame sequences in the appropriate direction (i.e., left or right).

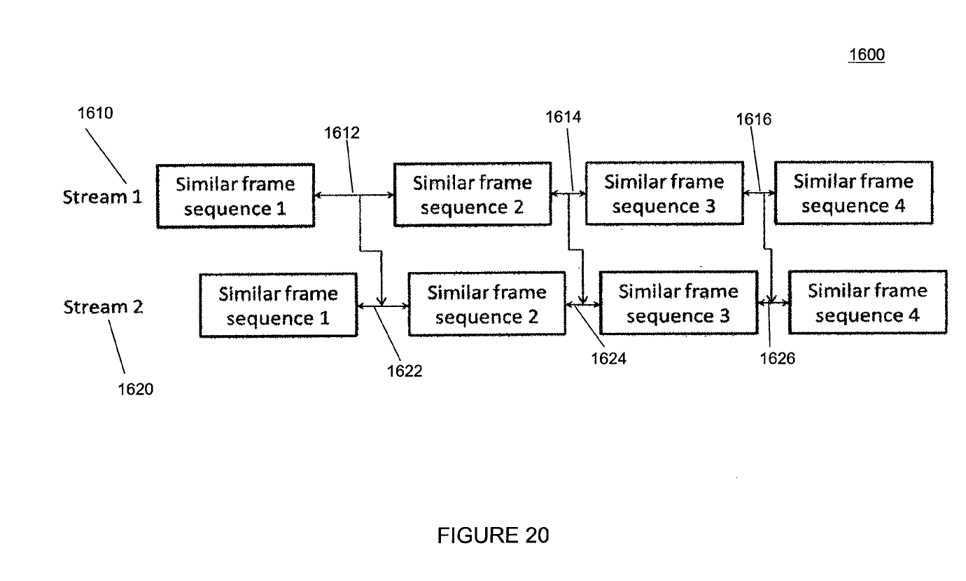

FIG. 20 illustrates an exemplary block diagram of a hole matching identification process 1600 via the content analysis server 210 of FIG. 6. The adaptive hole matching identification process 1600 analyzes streams 1 1610 and 2 1620. The stream 1 1610 includes holes 1612, 1614, and 1616 and similar frame sequences 1, 2, 3, and 4. The stream 2 1620 includes holes 1622, 1624, and 1626 and similar frame sequences 1, 2, 3, and 4. For each identified hole in stream 1 1610, the video segment comparison module 217 compares the hole with a corresponding hole between two adjacent similar frame sequences. In other words, the hole 1612 is compared to the hole 1622 because the holes 1612 and 1622 are between the similar frame sequences 1 and 2 in streams 1 1610 and 2 1610, respectively. Furthermore, the hole 1614 is compared to the hole 1624 because the holes 1614 and 1624 are between the similar frame sequences 2 and 3 in streams 1 1610 and 2 1610, respectively. The video segment comparison module 217 can compare the holes by determining the difference between the signatures for the compares hold, and determining if the difference is below the hold comparison threshold. If the difference is below the hold comparison threshold, the holes match report 1800.

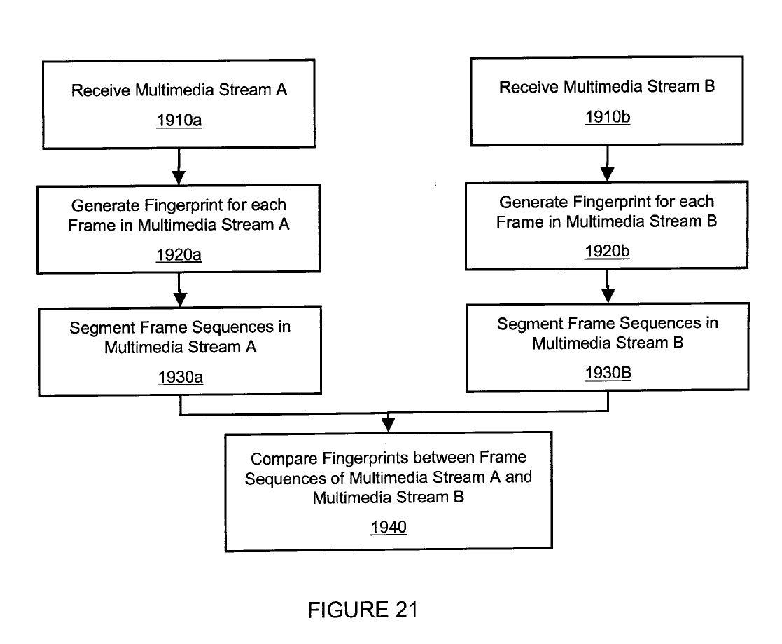

FIG. 21 illustrates an exemplary flow chart 1900 for comparing fingerprints between frame sequences utilizing the system 200 of FIG. 6. The communication module 211 receives (1910a) multimedia stream A and receives (1910b) multimedia stream B. The video fingerprint module 215 generates (1920a) a fingerprint for each frame in the multimedia stream A and generates (1920b) a fingerprint for each frame in the multimedia stream B. The video segmentation module 216 segments (1930a) frame sequences in the multimedia stream A together based on the fingerprints for each frame. The video segmentation module 216 segments (1930b) frame sequences in the multimedia stream A together based on the fingerprints for each frame. The video segment comparison module 217 compares the segmented frame sequences for the multimedia streams A and B to identify similar frame sequences between the multimedia streams.

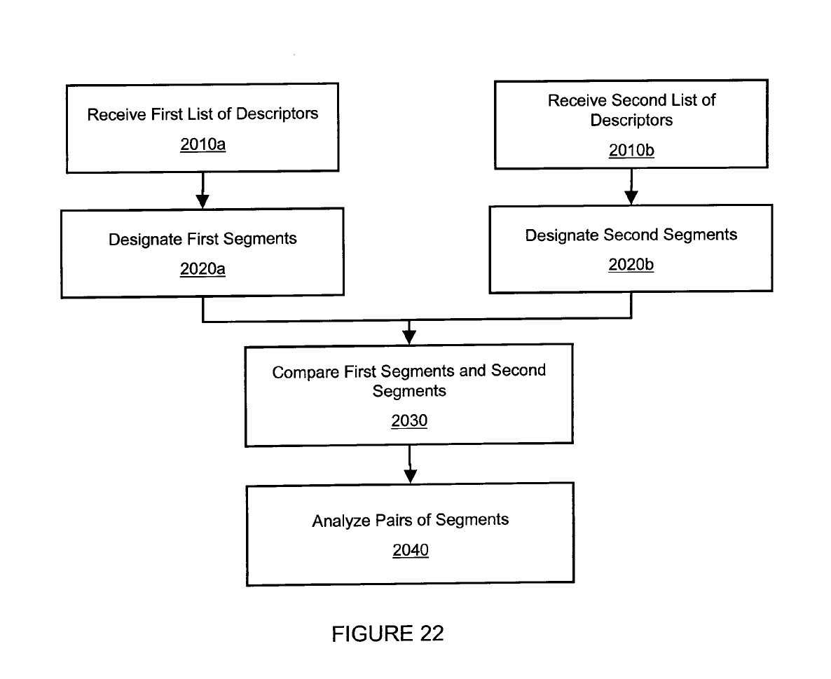

FIG. 22 illustrates an exemplary flow chart 2000 for comparing video sequences utilizing the system 200 of FIG. 6. The communication module 211 receives (2010a) a first list of descriptors pertaining to a plurality of first video frames. Each of the descriptors in the first line of descriptors represents visual information of a corresponding video frame of the plurality of first video frames. The communication module 211 receives (2010b) receives a second list of descriptors pertaining to a plurality of second video frames. Each of the descriptors in the second line of descriptors represents visual information of a corresponding video frame of the plurality of second video frames.

The video segmentation module 216 designates (2020a) first segments of the plurality of first video frames that are similar. Each segment of the first segments includes neighboring first video frames. The video segmentation module 216 designates (2020b) second segments of the plurality of second video frames that are similar. Each segment of the second segments includes neighboring second video frames.

The video segment comparison module 217 compares (2030) the first segments and the second segments. The video segment comparison module 217 analyzes (2040) the pairs of first and second segments based on the comparison of the first segments and the second segments to compare the first and second segments to a threshold value.

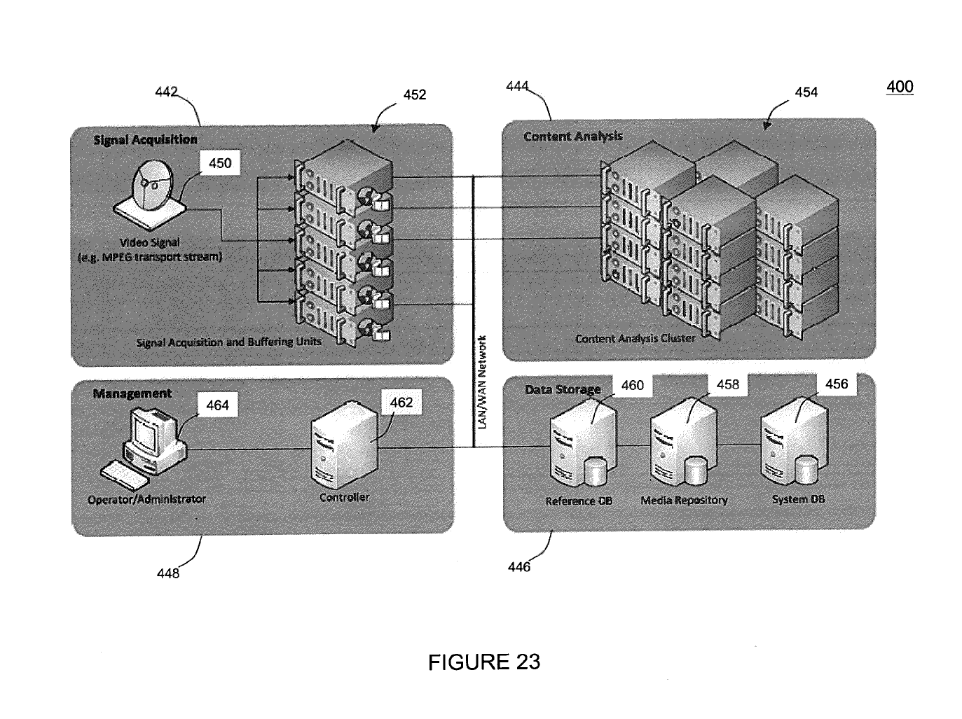

FIG. 23 illustrates a block diagram of an exemplary multi-channel video monitoring system 400. The system 400 includes (i) a signal, or media acquisition subsystem 442, (ii) a content analysis subsystem 444, (iii) a data storage subsystem 446, and (iv) a management subsystem 448.

The media acquisition subsystem 442 acquires one or more video signals 450 (e.g., corresponding to the channels broadcast from broadcast source 10). For each signal, the media acquisition subsystem 442 records it as data chunks on a number of signal buffer units 452. Depending on the use case, the buffer units 452 may perform fingerprint extraction as well, as described in more detail herein. Fingerprint extraction is described in more detail in International Patent Application Serial No. PCT/US2008/060164, entitled “Video Detection System And Methods,” incorporated above by reference in its entirety. This can be useful in a remote capturing scenario in which the very compact fingerprints are transmitted over a communications medium, such as the Internet, from a distant capturing site to a centralized content analysis site. The video detection system and processes may also be integrated with existing signal acquisition solutions, as long as the recorded data is accessible through a network connection.

The fingerprint for each data chunk can be stored in a media repository 458 portion of the data storage subsystem 446. In some embodiments, the data storage subsystem 446 includes one or more of a system repository 456 and a reference repository 460. One or more of the repositories 456, 458, 460 of the data storage subsystem 446 can include one or more local hard-disk drives, network accessed hard-disk drives, optical storage units, random access memory (RAM) storage drives, and/or any combination thereof. One or more of the repositories 456, 458, 460 can include a database management system to facilitate storage and access of stored content. In some embodiments, the system 440 supports different SQL-based relational database systems through its database access layer, such as Oracle and Microsoft-SQL Server. Such a system database acts as a central repository for all metadata generated during operation, including processing, configuration, and status information.

In some embodiments, the media repository 458 is serves as the main payload data storage of the system 440 storing the fingerprints, along with their corresponding key frames. A low quality version of the processed footage associated with the stored fingerprints is also stored in the media repository 458. The media repository 458 can be implemented using one or more RAID systems that can be accessed as a networked file system.

Each of the data chunk can become an analysis task that is scheduled for processing by a controller 462 of the management subsystem 48. The controller 462 is primarily responsible for load balancing and distribution of jobs to the individual nodes in a content analysis cluster 454 of the content analysis subsystem 444. In at least some embodiments, the management subsystem 448 also includes an operator/administrator terminal, referred to generally as a front-end 464. The operator/administrator terminal 464 can be used to configure one or more elements of the video detection system 440. The operator/administrator terminal 464 can also be used to upload reference video content for comparison and to view and analyze results of the comparison.

The signal buffer units 452 can be implemented to operate around-the-clock without any viewer interaction necessary. In such embodiments, the continuous video data stream is captured, divided into manageable segments, or chunks, and stored on internal hard disks. The hard disk space can be implanted to function as a circular buffer. In this configuration, older stored data chunks can be moved to a separate long term storage unit for archival, freeing up space on the internal hard disk drives for storing new, incoming data chunks. Such storage management provides reliable, uninterrupted signal availability over very long periods of time (e.g., hours, days, weeks, etc.). The controller 462 is configured to ensure timely processing of all data chunks so that no data is lost. The signal acquisition units 452 are designed to operate without any network connection, if required, (e.g., during periods of network interruption) to increase the system's fault tolerance.

In some embodiments, the signal buffer units 452 perform fingerprint extraction and transcoding on the recorded chunks locally. Storage requirements of the resulting fingerprints are trivial compared to the underlying data chunks and can be stored locally along with the data chunks. This enables transmission of the very compact fingerprints including a storyboard over limited-bandwidth networks, to avoid transmitting the full video content.

In some embodiments, the controller 462 manages processing of the data chunks recorded by the signal buffer units 452. The controller 462 constantly monitors the signal buffer units 452 and content analysis nodes 454, performing load balancing as required to maintain efficient usage of system resources. For example, the controller 462 initiates processing of new data chunks by assigning analysis jobs to selected ones of the analysis nodes 454. In some instances, the controller 462 automatically restarts individual analysis processes on the analysis nodes 454, or one or more entire analysis nodes 454, enabling error recovery without viewer interaction. A graphical viewer interface, can be provided at the front end 464 for monitor and control of one or more subsystems 442, 444, 446 of the system 400. For example, the graphical viewer interface allows a viewer to configure, reconfigure and obtain status of the content analysis 444 subsystem.

In some embodiments, the analysis cluster 444 includes one or more analysis nodes 454 as workhorses of the video detection and monitoring system. Each analysis node 454 independently processes the analysis tasks that are assigned to them by the controller 462. This primarily includes fetching the recorded data chunks, generating the video fingerprints, and matching of the fingerprints against the reference content. The resulting data is stored in the media repository 458 and in the data storage subsystem 446. The analysis nodes 454 can also operate as one or more of reference clips ingestion nodes, backup nodes, or RetroMatch nodes, in case the system performing retrospective matching. Generally, all activity of the analysis cluster is controlled and monitored by the controller.

After processing several such data chunks 470, the detection results for these chunks are stored in the system database 456. Beneficially, the numbers and capacities of signal buffer units 452 and content analysis nodes 454 may flexibly be scaled to customize the system's capacity to specific use cases of any kind. Realizations of the system 400 can include multiple software components that can be combined and configured to suit individual needs. Depending on the specific use case, several components can be run on the same hardware. Alternatively or in addition, components can be run on individual hardware for better performance and improved fault tolerance. Such a modular system architecture allows customization to suit virtually every possible use case. From a local, single-PC solution to nationwide monitoring systems, fault tolerance, recording redundancy, and combinations thereof.

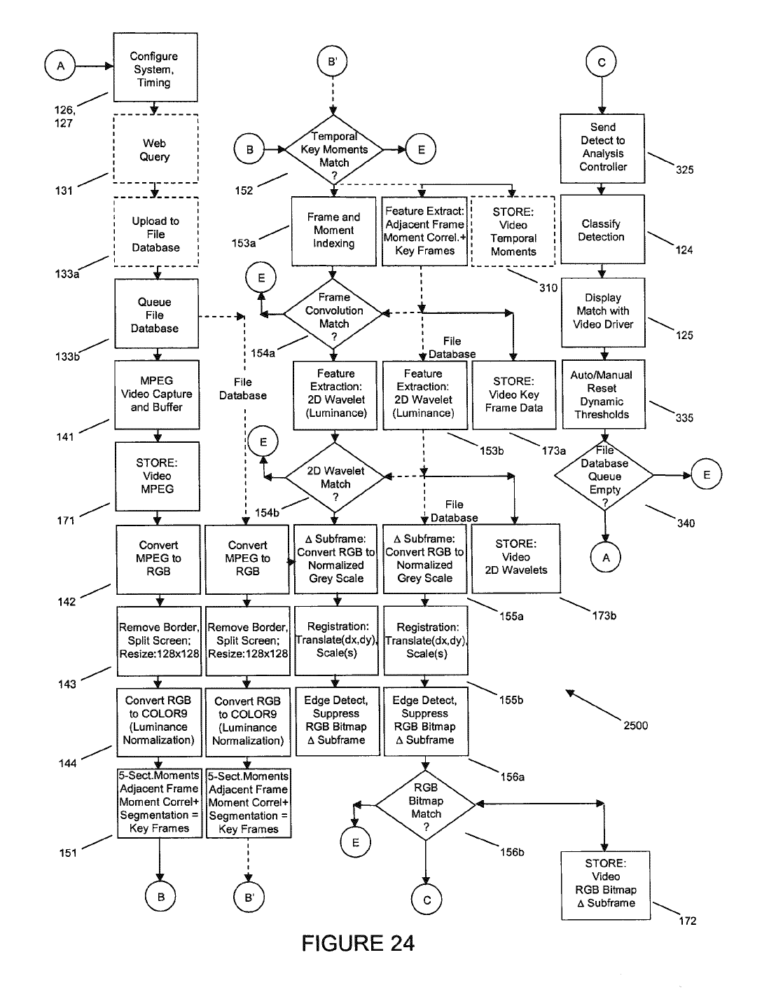

FIG. 24 illustrates an exemplary flow chart 2500 for the digital video image detection system 400 of FIG. 23. The flow chart 2500 initiates at a start point A with a viewer at a viewer interface 110 configuring the digital video image detection system 126, wherein configuring the system includes selecting at least one channel, at least one decoding method, and a channel sampling rate, a channel sampling time, and a channel sampling period. Configuring the system 126 includes one of: configuring the digital video image detection system manually and semi-automatically. Configuring the system 126 semi-automatically includes one or more of: selecting channel presets, scanning scheduling codes, and receiving scheduling feeds.

Configuring the digital video image detection system 126 further includes generating a timing control sequence 127, wherein a set of signals generated by the timing control sequence 127 provide for an interface to an MPEG video receiver.

In some embodiments, the method flow chart 2500 for the digital video image detection system 100 provides a step to optionally query the web for a file image 131 for the digital video image detection system to match. In some embodiments, the method flow chart 2500 provides a step to optionally upload from the viewer interface a file image for the digital video image detection system to match. In some embodiments, querying and queuing a file database 133b provides for at least one file image for the digital video image detection system to match.

The method flow chart 2500 further provides steps for capturing and buffering an MPEG video input at the MPEG video receiver and for storing the MPEG video input 171 as a digital image representation in an MPEG video archive.

The method flow chart 2500 further provides for steps of: converting the MPEG video image to a plurality of query digital image representations, converting the file image to a plurality of file digital image representations, wherein the converting the MPEG video image and the converting the file image are comparable methods, and comparing and matching the queried and file digital image representations. Converting the file image to a plurality of file digital image representations is provided by one of: converting the file image at the time the file image is uploaded, converting the file image at the time the file image is queued, and converting the file image in parallel with converting the MPEG video image.

The method flow chart 2500 provides for a method 142 for converting the MPEG video image and the file image to a queried RGB digital image representation and a file RGB digital image representation, respectively. In some embodiments, converting method 142 further comprises removing an image border 143 from the queried and file RGB digital image representations. In some embodiments, the converting method 142 further comprises removing a split screen 143 from the queried and file RGB digital image representations. In some embodiment, one or more of removing an image border and removing a split screen 143 includes detecting edges. In some embodiments, converting method 142 further comprises resizing the queried and file RGB digital image representations to a size of 128×128 pixels.

The method flow chart 2500 further provides for a method 144 for converting the MPEG video image and the file image to a queried COLOR9 digital image representation and a file COLOR9 digital image representation, respectively. Converting method 144 provides for converting directly from the queried and file RGB digital image representations.

Converting method 144 includes steps of: projecting the queried and file RGB digital image representations onto an intermediate luminance axis, normalizing the queried and file RGB digital image representations with the intermediate luminance, and converting the normalized queried and file RGB digital image representations to a queried and file COLOR9 digital image representation, respectively.

The method flow chart 2500 further provides for a method 151 for converting the MPEG video image and the file image to a queried 5-segment, low resolution temporal moment digital image representation and a file 5-segment, low resolution temporal moment digital image representation, respectively. Converting method 151 provides for converting directly from the queried and file COLOR9 digital image representations.

Converting method 151 includes steps of: sectioning the queried and file COLOR9 digital image representations into five spatial, overlapping sections and non-overlapping sections, generating a set of statistical moments for each of the five sections, weighting the set of statistical moments, and correlating the set of statistical moments temporally, generating a set of key frames or shot frames representative of temporal segments of one or more sequences of COLOR9 digital image representations.

Generating the set of statistical moments for converting method 151 includes generating one or more of: a mean, a variance, and a skew for each of the five sections. In some embodiments, correlating a set of statistical moments temporally for converting method 151 includes correlating one or more of a means, a variance, and a skew of a set of sequenceially buffered RGB digital image representations.

Correlating a set of statistical moments temporally for a set of sequenceially buffered MPEG video image COLOR9 digital image representations allows for a determination of a set of median statistical moments for one or more segments of consecutive COLOR9 digital image representations. The set of statistical moments of an image frame in the set of temporal segments that most closely matches the a set of median statistical moments is identified as the shot frame, or key frame. The key frame is reserved for further refined methods that yield higher resolution matches.

The method flow chart 2500 further provides for a comparing method 152 for matching the queried and file 5-section, low resolution temporal moment digital image representations. In some embodiments, the first comparing method 151 includes finding an one or more errors between the one or more of: a mean, variance, and skew of each of the five segments for the queried and file 5-section, low resolution temporal moment digital image representations. In some embodiments, the one or more errors are generated by one or more queried key frames and one or more file key frames, corresponding to one or more temporal segments of one or more sequences of COLOR9 queried and file digital image representations. In some embodiments, the one or more errors are weighted, wherein the weighting is stronger temporally in a center segment and stronger spatially in a center section than in a set of outer segments and sections.

Comparing method 152 includes a branching element ending the method flow chart 2500 at ‘E’ if the first comparing results in no match. Comparing method 152 includes a branching element directing the method flow chart 2500 to a converting method 153 if the comparing method 152 results in a match.

In some embodiments, a match in the comparing method 152 includes one or more of: a distance between queried and file means, a distance between queried and file variances, and a distance between queried and file skews registering a smaller metric than a mean threshold, a variance threshold, and a skew threshold, respectively. The metric for the first comparing method 152 can be any of a set of well known distance generating metrics.

A converting method 153a includes a method of extracting a set of high resolution temporal moments from the queried and file COLOR9 digital image representations, wherein the set of high resolution temporal moments include one or more of: a mean, a variance, and a skew for each of a set of images in an image segment representative of temporal segments of one or more sequences of COLOR9 digital image representations.

Converting method 153a temporal moments are provided by converting method 151. Converting method 153a indexes the set of images and corresponding set of statistical moments to a time sequence. Comparing method 154a compares the statistical moments for the queried and the file image sets for each temporal segment by convolution.

The convolution in comparing method 154a convolves the queried and filed one or more of: the first feature mean, the first feature variance, and the first feature skew. In some embodiments, the convolution is weighted, wherein the weighting is a function of chrominance. In some embodiments, the convolution is weighted, wherein the weighting is a function of hue.

The comparing method 154a includes a branching element ending the method flow chart 2500 if the first feature comparing results in no match. Comparing method 154a includes a branching element directing the method flow chart 2500 to a converting method 153b if the first feature comparing method 153a results in a match.

In some embodiments, a match in the first feature comparing method 153a includes one or more of: a distance between queried and file first feature means, a distance between queried and file first feature variances, and a distance between queried and file first feature skews registering a smaller metric than a first feature mean threshold, a first feature variance threshold, and a first feature skew threshold, respectively. The metric for the first feature comparing method 153a can be any of a set of well known distance generating metrics.

The converting method 153b includes extracting a set of nine queried and file wavelet transform coefficients from the queried and file COLOR9 digital image representations. Specifically, the set of nine queried and file wavelet transform coefficients are generated from a grey scale representation of each of the nine color representations comprising the COLOR9 digital image representation. In some embodiments, the grey scale representation is approximately equivalent to a corresponding luminance representation of each of the nine color representations comprising the COLOR9 digital image representation. In some embodiments, the grey scale representation is generated by a process commonly referred to as color gamut sphering, wherein color gamut sphering approximately eliminates or normalizes brightness and saturation across the nine color representations comprising the COLOR9 digital image representation.

In some embodiments, the set of nine wavelet transform coefficients are one of: a set of nine one-dimensional wavelet transform coefficients, a set of one or more non-collinear sets of nine one-dimensional wavelet transform coefficients, and a set of nine two-dimensional wavelet transform coefficients. In some embodiments, the set of nine wavelet transform coefficients are one of: a set of Haar wavelet transform coefficients and a two-dimensional set of Haar wavelet transform coefficients.

The method flow chart 2500 further provides for a comparing method 154b for matching the set of nine queried and file wavelet transform coefficients. In some embodiments, the comparing method 154b includes a correlation function for the set of nine queried and filed wavelet transform coefficients. In some embodiments, the correlation function is weighted, wherein the weighting is a function of hue; that is, the weighting is a function of each of the nine color representations comprising the COLOR9 digital image representation.

The comparing method 154b includes a branching element ending the method flow chart 2500 if the comparing method 154b results in no match. The comparing method 154b includes a branching element directing the method flow chart 2500 to an analysis method 155a-156b if the comparing method 154b results in a match.

In some embodiments, the comparing in comparing method 154b includes one or more of: a distance between the set of nine queried and file wavelet coefficients, a distance between a selected set of nine queried and file wavelet coefficients, and a distance between a weighted set of nine queried and file wavelet coefficients.

The analysis method 155a-156b provides for converting the MPEG video image and the file image to one or more queried RGB digital image representation subframes and file RGB digital image representation subframes, respectively, one or more grey scale digital image representation subframes and file grey scale digital image representation subframes, respectively, and one or more RGB digital image representation difference subframes. The analysis method 155a-156b provides for converting directly from the queried and file RGB digital image representations to the associated subframes.

The analysis method 55a-156b provides for the one or more queried and file grey scale digital image representation subframes 155a, including: defining one or more portions of the queried and file RGB digital image representations as one or more queried and file RGB digital image representation subframes, converting the one or more queried and file RGB digital image representation subframes to one or more queried and file grey scale digital image representation subframes, and normalizing the one or more queried and file grey scale digital image representation subframes.

The method for defining includes initially defining identical pixels for each pair of the one or more queried and file RGB digital image representations. The method for converting includes extracting a luminance measure from each pair of the queried and file RGB digital image representation subframes to facilitate the converting. The method of normalizing includes subtracting a mean from each pair of the one or more queried and file grey scale digital image representation subframes.

The analysis method 155a-156b further provides for a comparing method 155b-156b. The comparing method 155b-156b includes a branching element ending the method flow chart 2500 if the second comparing results in no match. The comparing method 155b-156b includes a branching element directing the method flow chart 2500 to a detection analysis method 325 if the second comparing method 155b-156b results in a match.

The comparing method 155b-156b includes: providing a registration between each pair of the one or more queried and file grey scale digital image representation subframes 155b and rendering one or more RGB digital image representation difference subframes and a connected queried RGB digital image representation dilated change subframe 156a-b.

The method for providing a registration between each pair of the one or more queried and file grey scale digital image representation subframes 155b includes: providing a sum of absolute differences (SAD) metric by summing the absolute value of a grey scale pixel difference between each pair of the one or more queried and file grey scale digital image representation subframes, translating and scaling the one or more queried grey scale digital image representation subframes, and repeating to find a minimum SAD for each pair of the one or more queried and file grey scale digital image representation subframes. The scaling for method 155b includes independently scaling the one or more queried grey scale digital image representation subframes to one of: a 128×128 pixel subframe, a 64×64 pixel subframe, and a 32×32 pixel subframe.

The scaling for method 155b includes independently scaling the one or more queried grey scale digital image representation subframes to one of: a 720×480 pixel (480i/p) subframe, a 720×576 pixel (576 i/p) subframe, a 1280×720 pixel (720p) subframe, a 1280×1080 pixel (1080i) subframe, and a 1920×1080 pixel (1080p) subframe, wherein scaling can be made from the RGB representation image or directly from the MPEG image.

The method for rendering one or more RGB digital image representation difference subframes and a connected queried RGB digital image representation dilated change subframe 156a-b includes: aligning the one or more queried and file grey scale digital image representation subframes in accordance with the method for providing a registration 155b, providing one or more RGB digital image representation difference subframes, and providing a connected queried RGB digital image representation dilated change subframe.

The providing the one or more RGB digital image representation difference subframes in method 56a includes: suppressing the edges in the one or more queried and file RGB digital image representation subframes, providing a SAD metric by summing the absolute value of the RGB pixel difference between each pair of the one or more queried and file RGB digital image representation subframes, and defining the one or more RGB digital image representation difference subframes as a set wherein the corresponding SAD is below a threshold.

The suppressing includes: providing an edge map for the one or more queried and file RGB digital image representation subframes and subtracting the edge map for the one or more queried and file RGB digital image representation subframes from the one or more queried and file RGB digital image representation subframes, wherein providing an edge map includes providing a Sobol filter.

The providing the connected queried RGB digital image representation dilated change subframe in method 56a includes: connecting and dilating a set of one or more queried RGB digital image representation subframes that correspond to the set of one or more RGB digital image representation difference subframes.

The method for rendering one or more RGB digital image representation difference subframes and a connected queried RGB digital image representation dilated change subframe 156a-b includes a scaling for method 156a-b independently scaling the one or more queried RGB digital image representation subframes to one of: a 128×128 pixel subframe, a 64×64 pixel subframe, and a 32×32 pixel subframe.

The scaling for method 156a-b includes independently scaling the one or more queried RGB digital image representation subframes to one of: a 720×480 pixel (480i/p) subframe, a 720×576 pixel (576 i/p) subframe, a 1280×720 pixel (720p) subframe, a 1280×1080 pixel (1080i) subframe, and a 1920×1080 pixel (1080p) subframe, wherein scaling can be made from the RGB representation image or directly from the MPEG image.

The method flow chart 2500 further provides for a detection analysis method 325. The detection analysis method 325 and the associated classify detection method 124 provide video detection match and classification data and images for the display match and video driver 125, as controlled by the viewer interface 110. The detection analysis method 325 and the classify detection method 124 further provide detection data to a dynamic thresholds method 335, wherein the dynamic thresholds method 335 provides for one of: automatic reset of dynamic thresholds, manual reset of dynamic thresholds, and combinations thereof.

The method flow chart 2500 further provides a third comparing method 340, providing a branching element ending the method flow chart 2500 if the file database queue is not empty.

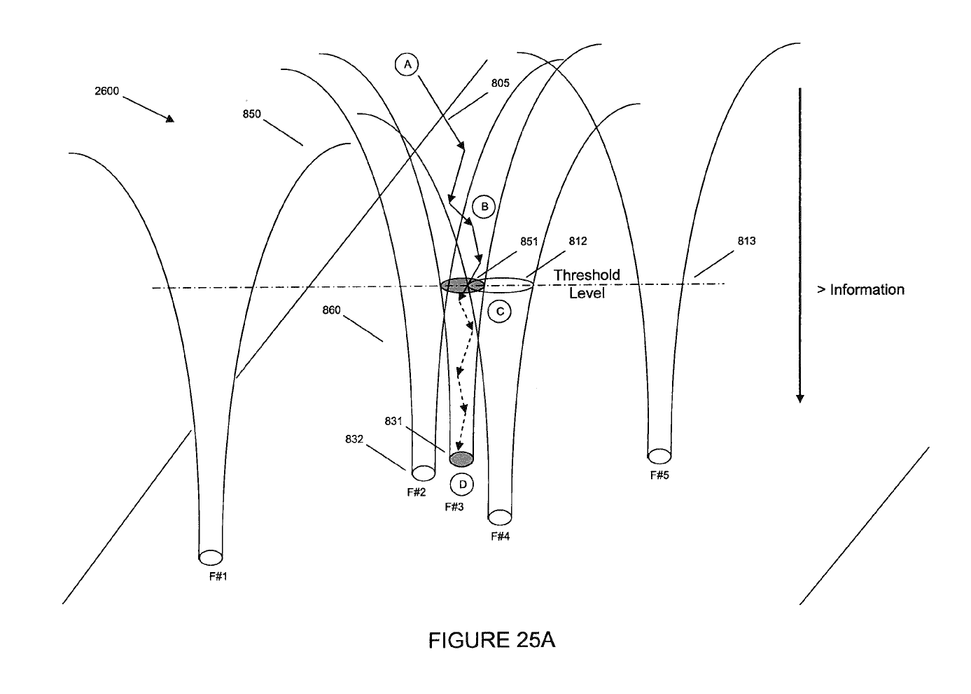

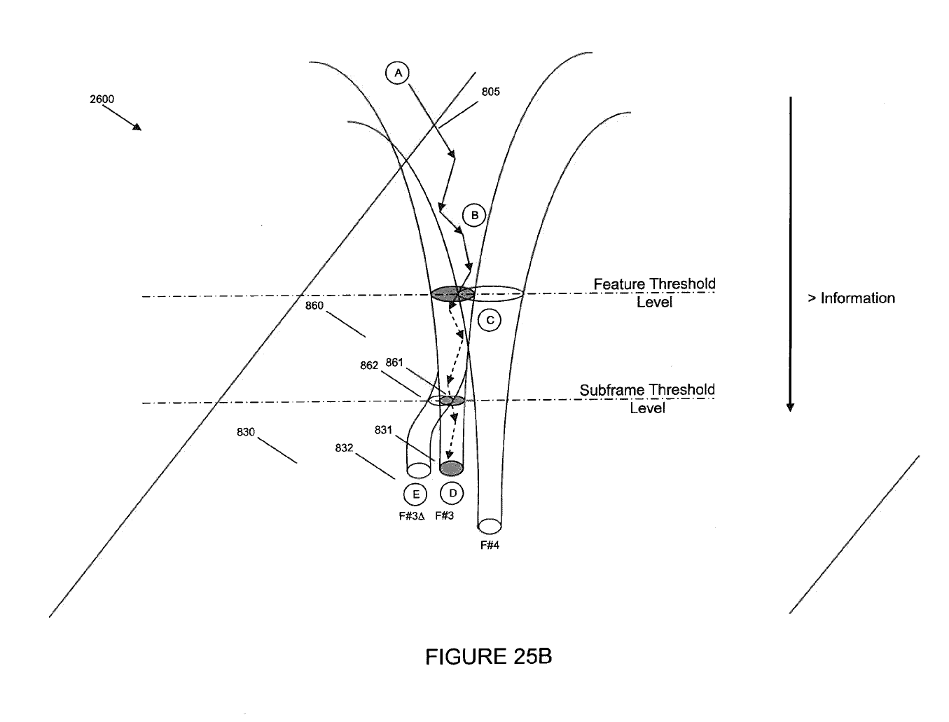

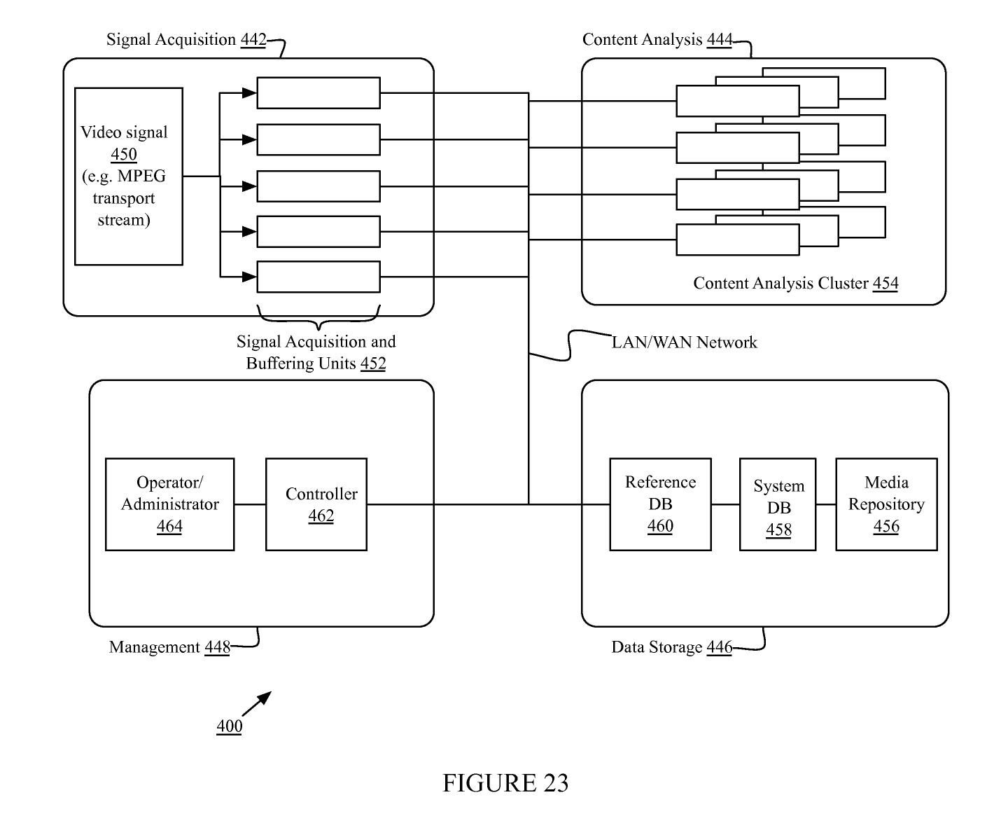

FIG. 25A illustrates an exemplary traversed set of K-NN nested, disjoint feature subspaces in feature space 2600. A queried image 805 starts at A and is funneled to a target file image 831 at D, winnowing file images that fail matching criteria 851 and 852, such as file image 832 at threshold level 813, at a boundary between feature spaces 850 and 860.

FIG. 25B illustrates the exemplary traversed set of K-NN nested, disjoint feature subspaces with a change in a queried image subframe. The a queried image 805 subframe 861 and a target file image 831 subframe 862 do not match at a subframe threshold at a boundary between feature spaces 860 and 830. A match is found with file image 832, and a new subframe 832 is generated and associated with both file image 831 and the queried image 805, wherein both target file image 831 subframe 961 and new subframe 832 comprise a new subspace set for file target image 832.

In some examples, the content analysis server 410 of FIG. 5 is a Web portal. The Web portal implementation allows for flexible, on demand monitoring offered as a service. With need for little more than web access, a web portal implementation allows clients with small reference data volumes to benefit from the advantages of the video detection systems and processes of the present invention. Solutions can offer one or more of several programming interfaces using Microsoft .Net Remoting for seamless in-house integration with existing applications. Alternatively or in addition, long-term storage for recorded video data and operative redundancy can be added by installing a secondary controller and secondary signal buffer units.

### CONCLUSION

The above-described systems and methods can be implemented in digital electronic circuitry, in computer hardware, firmware, and/or software. The implementation can be as a computer program product (i.e., a computer program tangibly embodied in an information carrier). The implementation can, for example, be in a machine-readable storage device, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a viewer, the above described techniques can be implemented on a computer having a display device. The display device can, for example, be a cathode ray tube (CRT) and/or a liquid crystal display (LCD) monitor. The interaction with a viewer can, for example, be a display of information to the viewer and a keyboard and a pointing device (e.g., a mouse or a trackball) by which the viewer can provide input to the computer (e.g., interact with a viewer interface element). Other kinds of devices can be used to provide for interaction with a viewer. Other devices can, for example, be feedback provided to the viewer in any form of sensory feedback (e.g., visual feedback, auditory feedback, or tactile feedback). Input from the viewer can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical viewer interface, a Web browser through which a viewer can interact with an example implementation, and/or other graphical viewer interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

The communication network can include, for example, a packet-based network and/or a circuit-based network. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

The communication device can include, for example, a computer, a computer with a browser device, a telephone, an IP phone, a mobile device (e.g., cellular phone, personal digital assistant (PDA) device, laptop computer, electronic mail device), and/or other type of communication device. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a personal digital assistant (PDA).

In general, the term video refers to a sequence of still images, or frames, representing scenes in motion. Thus, the video frame itself is a still picture. The terms video and multimedia as used herein include television and film-style video clips and streaming media. Video and multimedia include analog formats, such as standard television broadcasting and recording and digital formats, also including standard television broadcasting and recording (e.g., DTV). Video can be interlaced or progressive. The video and multimedia content described herein may be processed according to various storage formats, including: digital video formats (e.g., DVD), QuickTime®, and MPEG 4; and analog videotapes, including VHS® and Betamax®. Formats for digital television broadcasts may use the MPEG-2 video codec and include: ATSC—USA, Canada DVB—Europe ISDB—Japan, Brazil DMB—Korea. Analog television broadcast standards include: FCS—USA, Russia; obsolete MAC—Europe; obsolete MUSE—Japan NTSC—USA, Canada, Japan PAL—Europe, Asia, Oceania PAL-M—PAL variation. Brazil PALplus—PAL extension, Europe RS-343 (military) SECAM—France, Former Soviet Union, Central Africa. Video and multimedia as used herein also include video on demand referring to videos that start at a moment of the viewer's choice, as opposed to streaming, multicast.

The present disclosure is not to be limited in terms of the particular embodiments described in this application, which are intended as illustrations of various aspects.

Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While certain embodiments of this invention have been particularly shown and described with references to preferred embodiments thereof, it will be understood by those skilled in the art that various changes in form and details may be made therein without departing from the scope of the invention encompassed by the appended claims.

1-37. (canceled)

38-73. (canceled)

74. A method comprising:
receiving a first descriptor corresponding to a broadcast media sequence;
comparing the first descriptor and a second descriptor corresponding to a reference media sequence;
generating broadcast information related to the broadcast media sequence based on the comparison of the first descriptor and the second descriptor; and
providing interactivity related to the broadcast media sequence to at least one viewer based on the broadcast information.

75. The method of claim 74, wherein providing interactivity related to the broadcast media sequence to at least one viewer comprises:
receiving viewer information from the at least one viewer; and
determining a relationship between the viewer information and the broadcast information.

76. The method of claim 75, wherein the broadcast information comprises:
broadcast match information indicative of a similarity between the first descriptor and the second descriptor.

77. The method of claim 76, wherein the broadcast information comprises at least one from the list consisting of:
broadcast location information indicative of a location in which the broadcast media sequence was broadcast;
broadcast platform information indicative of a platform over which the broadcast media sequence was broadcast; and
broadcast channel information indicative of a channel over which broadcast media sequence was broadcast.

78. The method of claim 75, wherein the viewer information comprises information related to the time of an action of the at least one viewer, and wherein determining the relationship between the viewer information and the broadcast information comprises:
determining, based on the broadcast information, action time information indicative of whether the time of the action corresponds to an event in the broadcast media sequence.

79. The method of claim 78, comprising determining, based on the action time information, whether the time of the action was within a defined time period of the event.

80. The method of claim 78, further comprising providing content to at least one device associated with the at least one viewer based on the action time information or the action location information.

81. The method of claim 75, further comprising selectively providing content to at least one device associated with the at least one viewer based on the relationship between the viewer information and the broadcast information.

82. The method of claim 81, wherein providing content comprises transmitting an instruction to a content provider to deliver content to a device associated with the at least one viewer.

83. The method of claim 75, further comprising selectively storing information associated with the viewer based on the relationship between the viewer information and the broadcast information.

84. The method of claim 75, wherein the viewer information comprises information related to the location of the at least one viewer at the time of the action, and wherein determining the relationship between the viewer information and the broadcast information comprises:
determining, based on the broadcast information, action location information indicative of whether the location of the at least one viewer at the time of the action corresponds to a location where the broadcast media sequence is available.

85. The method of claim 74, wherein generating broadcast information related to the broadcast media sequence based on the comparison of the first descriptor and the second descriptor comprises:
determining a similarity of the first and second descriptors; and
comparing the similarity to a threshold level.

86. The method of claim 85, wherein the broadcast information comprises threshold information indicative of whether the similarity exceeds the threshold level; and
wherein providing substantially real time content comprises:
generating a first list of descriptors, each descriptor corresponding to respective event in the broadcast media sequence;
comparing at least a first one from the first list of descriptors to a second list of descriptors to identify a first identified event in the broadcast media sequence; and
synchronizing a delivery of the real time content to the at least one viewer based on the first identified event.

87. The method of claim 86, wherein the descriptors in the first list of descriptors are (i) generated at distinct time intervals during the broadcast media sequence, or (ii) generated substantially continuously during the broadcast media sequence.

88. The method of claim 86, further comprising:
after the synchronizing step, comparing a second one from first list of descriptors to the second list of descriptors to identify a second event in the broadcast; and
re-synchronizing the delivery of the real time content to the at least one viewer based on the identified first event.

89. The method of claim 74, wherein providing interactivity related to the broadcast to at least one viewer comprises:
based on the broadcast information, providing substantially real time content to at least one device associated with the viewer related to an event in the broadcast media sequence.

90. The method of claim 89, wherein providing substantially real time content to the at least one viewer comprises delivering event content associated with a respective event in the broadcast media sequence substantially simultaneously with the event.

91. The method of claim 89, wherein content comprises at least one selected from the list consisting of: text content; audio content; video content; an image; and further comprising:
prior to the comparing step, receiving information from the at least one viewer indicating viewer interest in the broadcast.

92. The method of claim 74, wherein the broadcast information comprises:
broadcast identity information indicative of an identity of the media content of the broadcast media sequence; and
broadcast time information indicative of a time during which the broadcast media sequence was broadcast.

93. A computer program product comprising a non-transitory machine readable medium having instructions stored thereon, the instructions being executable by a data processing apparatus to implement the steps of the method of claim 74.

94. A system comprising:
a broadcast monitoring module configured to:
receive a first descriptor corresponding to a broadcast media sequence;
compare the first descriptor and a second descriptor corresponding to a reference media sequence; and
generate broadcast information related to the broadcast media sequence based on the comparison of the first descriptor and the second descriptor;
wherein the broadcast information is configured to facilitate providing interactivity related to the broadcast media sequence to at least one viewer.
